(19) United States
(12) Patent Application Publication
(10) Pub. No.: US 2025/0324465 A1
(43) Pub. Date: Oct. 16, 2025

(54) LOW LATENCY CHANNEL ACCESS FOR WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/091,678

(22) Filed: Mar. 26, 2025

Related U.S. Application Data
(60) Provisional application No. 63/634,170, filed on Apr. 15, 2024.
(60) Provisional application No. 63/638,658, filed on Apr. 25, 2024.
(60) Provisional application No. 63/638,724, filed on Apr. 25, 2024.
(60) Provisional application No. 63/663,438, filed on Jun. 24, 2024.
(60) Provisional application No. 63/678,934, filed on Aug. 2, 2024.
(60) Provisional application No. 63/684,755, filed on Aug. 19, 2024.

(51) Int. Cl. H04W 74/08; H04W 12/06; H04W 28/02; H04W 74/0816

(52) U.S. Cl. CPC H04W 74/0875; H04W 12/06; H04W 28/0268; H04W 74/0816

(57) ABSTRACT

An embodiment includes providing low latency applications with priority access to the wireless medium by giving the authorized device a prioritized enhanced distributed channel access (EDCA) parameter set where the values of the prioritized EDCA parameter set can be designed by the entity providing the set in such a manner that the authorized device using the parameter set can gain priority access to a channel compared to other devices that are not authorized, improving wireless communications and performance of low latency applications.

### CROSS-REFERENCE TO RELATED APPLICATIONS

This application claims the benefit of priority from U.S. Provisional Application No. 63/634,170, entitled “Low Latency Channel Access For Next Generation WLANS” filed Apr. 15, 2024; U.S. Provisional Application No. 63/638,658, entitled “Traffic Prioritization for Next Generation WLANS” filed Apr. 25, 2024; U.S. Provisional Application No. 63/638,724, entitled “Low Latency Traffic Handling for Next Generation WLANS” filed Apr. 25, 2024; U.S. Provisional Application No. 63/663,438, entitled “Authorization Procedures for Low Latency Application Support in Next Generation WLANS” filed Jun. 24, 2024; U.S. Provisional Application No. 63/678,934, entitled “Low Latency Channel Access for Next Generation WLANS” filed Aug. 2, 2024; and U.S. Provisional Application No. 63/684,755, entitled “Update Procedures for Low Latency Handling in Next Generation WLANS” filed Aug. 19, 2024; which are all incorporated herein by reference in their entireties.

### TECHNICAL FIELD

This disclosure relates generally to a wireless communication system, and more particularly to, for example, but not limited to, low latency channel access for wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure a station (STA) in a wireless network, the STA comprising: a memory; and a processor coupled to the memory. The processor is configured to determine that the STA has low-latency traffic to be transmitted. The processor is configured to determine that the STA is authorized for priority access to a channel. The processor is configured to contend for the channel using a prioritized enhanced distributed channel access (EDCA) parameter set, the prioritized EDCA parameter set providing priority access to the channel. The processor is configured to transmit, to an access point (AP), the low-latency traffic via the channel.

In some embodiments, the processor is further configured to determine that the STA is authorized for priority access to the channel based on a determination that a latency tolerance indicated by a quality of service (QOS) established between the STA and the AP is less than a channel access delay.

In some embodiments, the processor is configured to determine that the STA is authorized for priority access to the channel based on a determination that a number of packet drops due to latency requirement exceed a threshold.

In some embodiments, the processor is further configured to: transmit, to the AP, a request frame that requests priority access to the channel; and receive, from the AP, a response frame in response to the request frame that authorizes priority access to the channel and includes the prioritized EDCA parameter set.

In some embodiments, the processor is further configured to receive, from the AP, an unsolicited frame that authorizes priority access to the channel and includes the prioritized EDCA parameter set.

In some embodiments, the processor is further configured to receive, from the AP, a frame that terminates authorization for priority access to the channel; and contend for the channel using a non-priority EDCA parameter set.

In some embodiments, the processor is further configured to: receive, from the AP, a frame that authorized priority access to the channel and includes a plurality of prioritized EDCA parameter sets including a first prioritized EDCA parameter set and a second prioritized EDCA parameter set; transmit, to the AP, a first low-latency traffic using the first prioritized EDCA parameter set; and transmit, to the AP, a second low-latency traffic using the second prioritized EDCA parameter set.

In some embodiments, the processor is further configured to: transmit a defer signal using the prioritized EDCA parameter set to block one or more STAs from contending for the channel during a time period.

One aspect of the present disclosure provides an access point (AP) in a wireless network, the AP comprising: a memory; and a processor coupled to the memory. The processor is configured to transmit, to a station (STA), a frame that includes a prioritized enhanced distributed channel access (EDCA) parameter set, the prioritized EDCA parameter set providing priority access to a channel. The processor is configured to receive, from the STA, the low-latency traffic via the channel, the low-latency traffic being transmitted based on the prioritized EDCA parameter set.

In some embodiments, the processor is configured to receive, from the STA, a request frame that request priority access to the channel, wherein the frame is transmitted in response to the request frame.

In some embodiments, the request frame indicates that a latency tolerance indicated by a quality of service (QOS) established between the STA and the AP is less than a channel access delay.

In some embodiments, the request frame indicates that a number of packet drops due to latency requirement exceed a threshold.

In some embodiments, the frame that includes the prioritized EDCA parameter set is an unsolicited frame.

In some embodiments, the processor is further configured to transmit, to the STA, another frame that terminates authorization for priority access to the channel.

In some embodiments, the frame includes a plurality of prioritized EDCA parameter sets including a first prioritized EDCA parameter set and a second prioritized EDCA parameter set; wherein the processor is further configured to: receive, from the STA, a first low-latency traffic that is transmitted based on the first prioritized EDCA parameter set; and receive, from the STA, a second low-latency traffic that is transmitted based on the second prioritized EDCA parameter set.

In some embodiments, the processor is further configured to: transmit a defer signal using the prioritized EDCA parameter set to block one or more STAs from contending for the channel during a time period.

One aspect of the present disclosure provides a computer-implemented method for wireless communication by a station (STA) in a wireless network. The method comprises determining that the STA has low-latency traffic to be transmitted. The method comprises determining that the STA is authorized for priority access to a channel. The method comprises contending for the channel using a prioritized enhanced distributed channel access (EDCA) parameter set, the prioritized EDCA parameter set providing priority access to the channel. The method comprises transmitting, to an access point (AP), the low-latency traffic via the channel.

In some embodiments, the method comprises determining that the STA is authorized for priority access to the channel based on a determination that a latency tolerance indicated by a quality of service (QOS) established between the STA and the AP is less than a channel access delay.

In some embodiments, the method further comprises determining that the STA is authorized for priority access to the channel based on a determination that a number of packet drops due to latency requirement exceed a threshold.

In some embodiments, the method further comprises transmitting, to the AP, a request frame that requests priority access to the channel; and receiving, from the AP, a response frame in response to the request frame that authorizes priority access to the channel and includes the prioritized EDCA parameter set.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a flow chart of an example process by a station (STA) for priority access for low latency application support in accordance with an embodiment.

FIG. 5 illustrates a flow chart of an example process by an AP for quality of service (QoS) based priority access authorization in accordance with an embodiment.

FIG. 6 illustrates a flow chart of an example process by a STA for packet drop based priority access authorization in accordance with an embodiment.

FIG. 7 illustrates a flow chart of an example process by a STA for priority access enable request in accordance with an embodiment.

FIG. 8 illustrates a flow chart of an example process for priority access enable response in accordance with an embodiment.

FIG. 9 illustrates a flow chart of an example process by an AP for priority access update in accordance with an embodiment.

FIG. 10 illustrates a flow chart of an example process by an AP for priority access termination in accordance with an embodiment.

FIG. 11 illustrates a stream classification service (SCS) setup in accordance with an embodiment.

FIG. 12A illustrates an example topology with packet latency requirements in accordance with an embodiment.

FIG. 12B illustrates an example of a packet expiration that may occur prior to a low-latency (LL) session setup in accordance with an embodiment.

FIG. 13A illustrates an example where an STA has obtained authorization for prioritized enhanced distributed channel access (EDCA).

FIG. 13B illustrates an example of packet transmission after an LL session setup in accordance with an embodiment.

FIG. 14 illustrates an EDCA parameter set that specifies parameters for each access category (AC) queue in accordance with an embodiment.

FIG. 15 illustrates a flow chart of an example process for EDCA parameter set enhancement in accordance with an embodiment.

FIG. 16 illustrates an example of a prioritized EDCA parameter set in accordance with an embodiment.

FIG. 17 illustrates another example of a prioritized EDCA parameter set in accordance with an embodiment.

FIG. 18 illustrates an example of a multi-link device (MLD) with prioritized EDCA parameter set and normal parameter set in accordance with an embodiment.

FIG. 19 illustrates a flow chart of an example process by a STA for using prioritized EDCA for channel access in accordance with an embodiment.

FIG. 20 illustrates an example operation of transmit level enhancement in accordance with an embodiment.

FIG. 21 illustrates an example operation of AC level enhancement in accordance with an embodiment.

FIG. 22 illustrates a queue management based prioritization in accordance with an embodiment.

FIG. 23 illustrates LL stream individual queues in accordance with an embodiment.

FIG. 24A illustrates a single LL stream queue with multiple prioritized EDCA parameter sets in accordance with an embodiment.

FIG. 24B illustrates alternative queues that include LL traffic and normal traffic for a particular AC in accordance with an embodiment.

FIG. 24C illustrates alternative queues that include LL traffic and normal traffic, each having a set of EDCA parameters, for an AC in accordance with an embodiment.

FIG. 25 illustrates a flow chart of an example process for degradation based prioritization in accordance with an embodiment.

FIG. 26 illustrates a flow chart of an example process for class A authorization policy in accordance with an embodiment.

FIG. 27 illustrates a flow chart of an example process for a class A traffic treatment policy in accordance with an embodiment.

FIG. 28 illustrates a flow chart of an example process for Class B authorization policy in accordance with an embodiment.

FIG. 29 illustrates a flow chart of an example process for Class B traffic treatment policy in accordance with an embodiment.

FIG. 30 illustrates a flow chart of an example process for a Class C authorization policy in accordance with an embodiment.

FIG. 31 illustrates a flow chart of an example process for a Class C traffic treatment policy in accordance with an embodiment.

FIG. 32 illustrates a flow chart of an example process by an STA for priority access authorization for STA in accordance with an embodiment.

FIG. 33 illustrates a flow chart of an example process by an AP for priority access authorization for an STA in accordance with an embodiment.

FIG. 34 illustrates a flow chart of an example process by a STA of a request based priority access authorization in accordance with an embodiment.

FIG. 35 illustrates a flow chart of an example process by an AP for authorization of an STA for priority access in accordance with an embodiment.

FIG. 36 illustrates an example of a request and response procedure in accordance with an embodiment.

FIG. 37 illustrates a flow chart of an example process by a STA for priority access enable request handling in accordance with an embodiment.

FIG. 38 illustrates a flow chart of an example process by an AP for priority access enable response frame handling in accordance with an embodiment.

FIG. 39 illustrates a flow chart of an example process by an AP for unsolicited priority access enable procedure in accordance with an embodiment.

FIG. 40 illustrates an example unsolicited priority access enable procedure in accordance with an embodiment.

FIG. 41 illustrates an example of need based indication in accordance with an embodiment.

FIG. 42 illustrates an example process for quality of service (QOS) based indication in accordance with an embodiment.

FIG. 43 illustrates a flow chart of an example process by an STA for priority access authorization in accordance with an embodiment.

FIG. 44 illustrates a flow chart of an example process by an AP for low latency authorization in accordance with an embodiment.

FIG. 45 illustrates enhanced BSR based authorization in accordance with an embodiment.

FIG. 46 illustrates a flow chart of an example process by an AP for EDCA parameter handling in accordance with an embodiment.

FIG. 47 illustrates a flow chart of an example process by a STA for EDCA parameter handling in accordance with an embodiment.

FIG. 48 illustrates a flow chart of an example process by a STA for EDCA parameter handling in accordance with an embodiment.

FIG. 49 illustrates an example of multi-link authorization in accordance with an embodiment.

FIG. 50 illustrates an example multi-link priority access authorization in accordance with an embodiment.

FIG. 51 illustrates an example for priority access authorization within a time duration in accordance with an embodiment.

FIG. 52 illustrates an example priority access with an explicit teardown in accordance with an embodiment.

FIG. 53 illustrates a priority access enable request element in accordance with an embodiment.

FIG. 54 illustrates a priority access enable response element in accordance with an embodiment.

FIG. 55 illustrates an update EDCA Info field format in accordance with an embodiment.

FIG. 56 illustrates a parameter record field format in accordance with an embodiment.

FIG. 57 illustrates a access category index (ACI)/arbitration interframe spacing number (AIFSN) field format in accordance with an embodiment.

FIG. 58 illustrates a exponent contention window minimum (ECWmin)/exponent contention window maximum (ECWmax) field format in accordance with an embodiment.

FIG. 59 illustrates an enhanced SCS request format in accordance with an embodiment.

FIG. 60 illustrates an SCS response format in accordance with an embodiment.

FIG. 61 illustrates a flow chart of an example process by an STA of an LL session teardown and re-setup procedure in accordance with an embodiment.

FIG. 62 illustrates a flow chart of an example process by an AP of a prioritized EDCA parameter update in accordance with an embodiment.

FIG. 63 illustrates a flow chart of an example process by an AP of an advertised capability-based teardown and reset up in accordance with an embodiment.

FIG. 64 illustrates a flow chart of an example process of by an AP of an unsolicited update message in accordance with an embodiment.

FIG. 65 illustrates a flow chart of an example process by an AP of management frame-based update procedure in accordance with an embodiment.

FIG. 66 illustrates a flow chart of an example process by a STA for management-based update procedure in accordance with an embodiment.

FIG. 67 illustrates a flow chart of an example process by an AP of degrading the normal EDCA parameter set in accordance with an embodiment.

FIG. 68 illustrates a flow chart of an example process by an AP of returning EDCA values to their original state in accordance with an embodiment.

FIG. 69 illustrates a stream classification service (SCS) response frame structure in accordance with an embodiment.

FIG. 70 illustrates an example EDCA update operation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

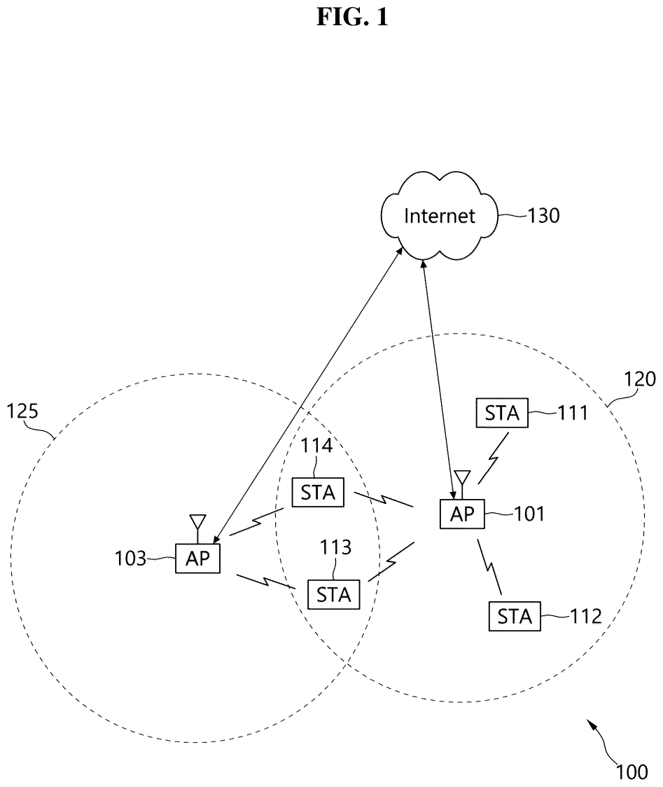

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

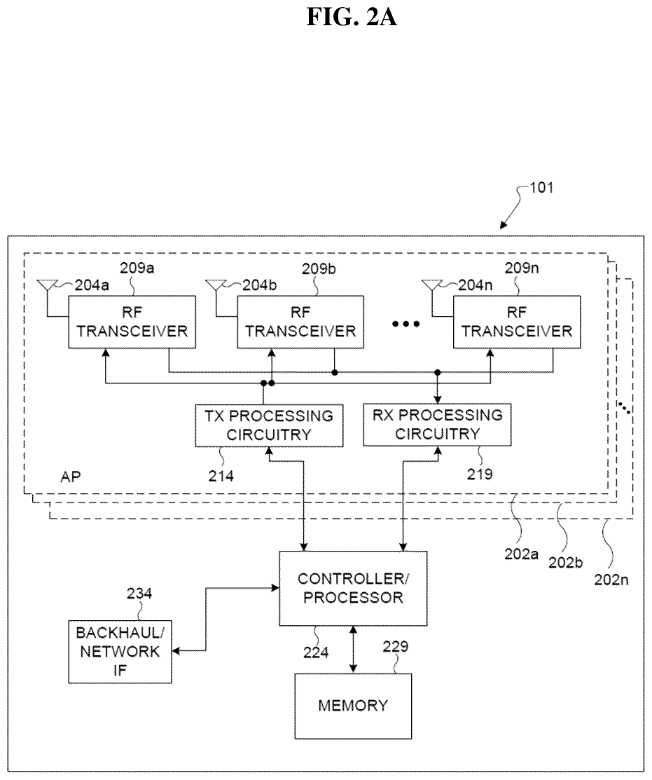

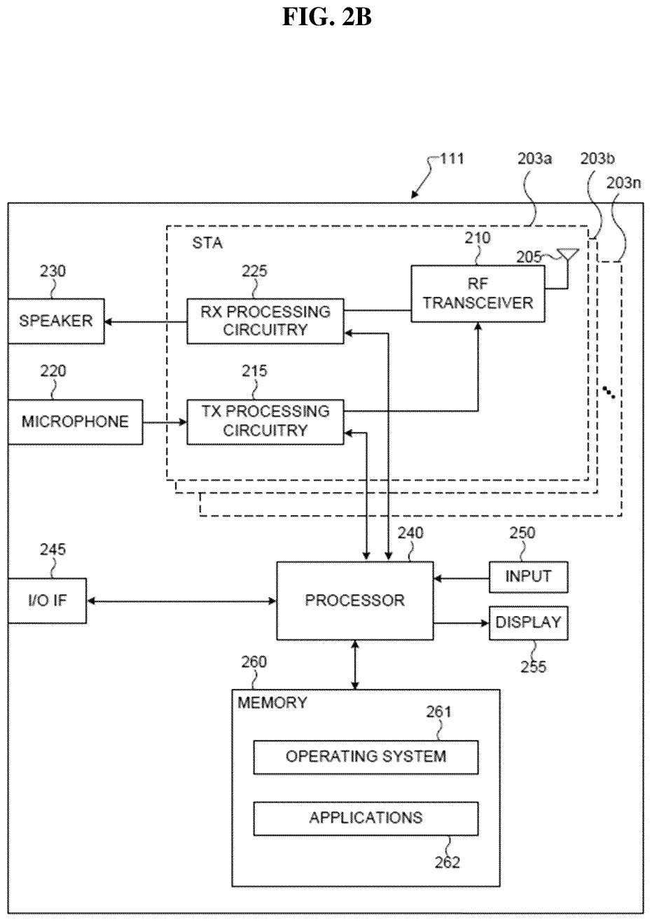

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

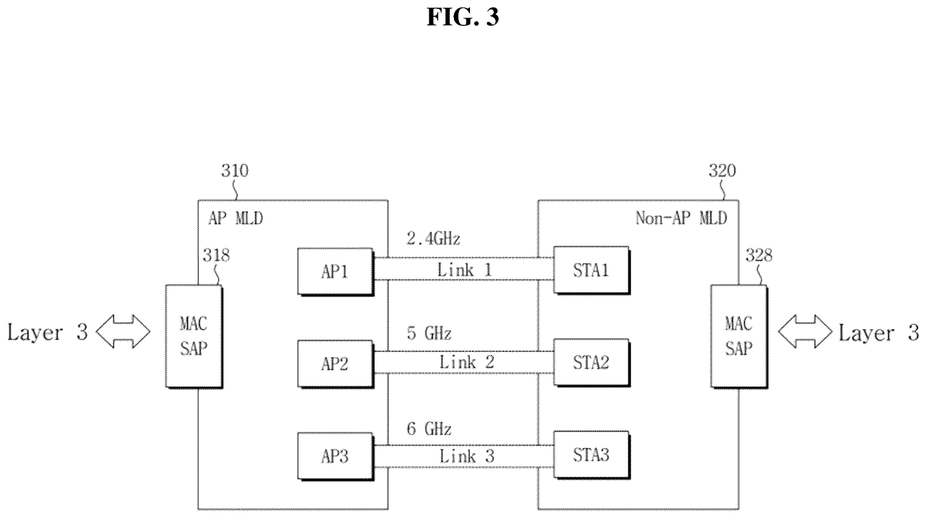

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

A bottleneck in wireless networks may be a channel access delay that a device encounters when attempting to transmit data. A channel access delay may increase based on various factors including a number of users in the network, a user's traffic load, data rates, among other factors. To support applications with low latency (LL) requirements, features that can reduce the time to access the channel may be beneficial. The next generation of WLAN may incorporate the concept of preemption to prioritize LL traffic. In some embodiments, the preemption services as a mechanism to stop current ongoing transmissions and initiate LL traffic transmission, ensuring that the delay bound is met in time.

In some embodiments, a low latency application can be provided with priority access to the wireless medium. In some embodiments, priority access can be provided by giving the authorized device a prioritized Enhanced Distributed Channel Access (EDCA) parameter set. As used herein, the terms prioritized EDCA or enhanced EDCA may be used interchangeably. As used herein, the terms priority access, low latency access, low latency session and priority access session may be used interchangeably. The values of the prioritized EDCA parameter set can be set by an authorizing entity (e.g., AP) in a manner that the authorized device, when using the parameter set, may have a higher probability of obtaining access to the channel compared to legacy devices that use normal EDCA parameters. As described herein, the term STA can refer to an AP STA or non-AP STA.

In some embodiments, a STA with a low latency traffic backlog may transmit a defer signal (DS), which may be referred to herein as a blocking signal, defer message, or blocking message, in order to block other devices (e.g., devices that cannot or have not transmitted such a defer signal, among others) from contending for the wireless medium for a certain period of time. In some embodiments, the defer signal may be transmitted using a prioritized EDCA parameter set. In some embodiments, a defer signal is a signal that prevents a different STA (e.g., a legacy STA) from contending for channel access. In some embodiments, a defer signal can be designed such that it can cause the PHY-RXEND.indication primitive to include an error or a frame for which the frame check sequence (FCS) value is incorrect. In some embodiments, the defer signal's modulation can be used to control the duration for which a legacy STA is blocked from contending for the wireless medium. In some embodiments, depending on a modulation scheme, a legacy device may compute an extended interframe space (EIFS) duration which may vary based on the modulation scheme of a frame that pushed the legacy device into the EIFS state, and the EIFS duration may be a time during which the legacy device will not access the channel. Blocking other devices from contending for the wireless medium for a certain period of time and/or transmitting frames using prioritized a EDCA parameter set may be referred to herein as a protected short contention period, prioritized EDCA, or enhanced EDCA. In particular, a protected short contention period may be a duration of time during which other devices are blocked from contending for a channel and only the devices that have transmitted a defer signal may contend for the channel.

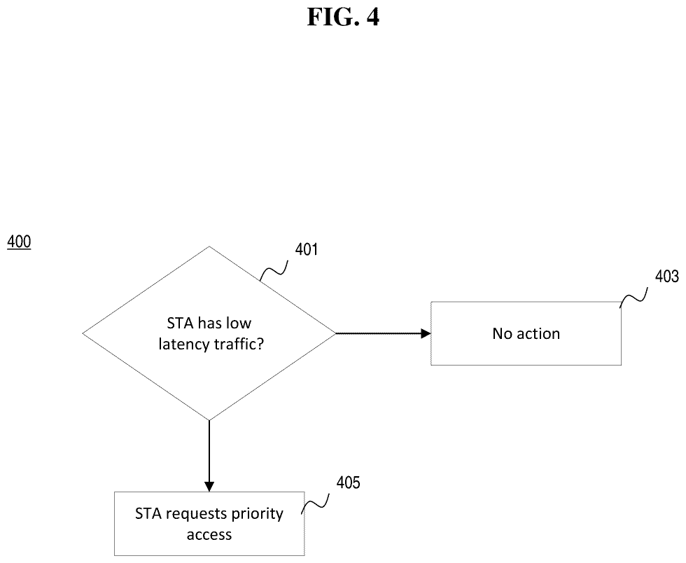

FIG. 4 illustrates a flow chart of an example process by a station (STA) for priority access for low latency application support in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 4 illustrates operations performed in a STA, such as the STA illustrated in FIG. 3.

The process 400, in operation 401, the STA determines whether it has low latency (LL) traffic. In some embodiments, low latency traffic may include traffic of frames whose delay tolerance (e.g., packet expiration) is less than an STA's channel access delay for the wireless medium. If the STA determines that it does not have LL traffic, the process proceeds to operation 403 and the STA performs no action. If the STA determines that it does have LL traffic, the process proceeds to operation 405.

In operation 405, the STA transmits to an AP a request for priority access (e.g., to be able to use a prioritized EDCA parameter set). In some embodiments, the station can be authorized based on a number of criteria. For example, the STA can setup a quality of service (QOS) with the AP and if the latency tolerance indicated by the STA in the QoS is lower or comparable to the channel access delay, then the AP can authorize the STA to perform priority access operation and provide a prioritized EDCA parameter set.

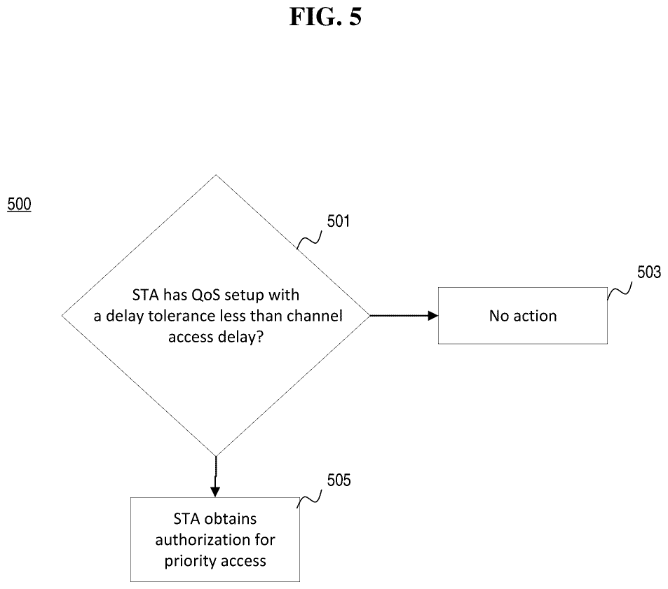

FIG. 5 illustrates a flow chart of an example process by an AP for quality of service (QoS) based priority access authorization in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 5 illustrates operations performed in a AP, such as the AP illustrated in FIG. 3.

The process 500, in operation 501, the AP determines whether a STA has a QoS setup with a delay tolerance less than a channel access delay. The QoS may provide information regarding the traffic characteristics of the STA, including frame expiration information, end-to-end transmission time requirement information, among others. If the AP determines that the STA does not have a QoS setup with a delay tolerance less than a channel access delay, the process proceeds to operation 503 and the AP performs no action. If AP determines that the STA does have a QoS setup with a delay tolerance less than a channel access delay, the process proceeds to operation 505.

In operation 505, the AP authorizes the STA for priority access. Accordingly, the STA may contend for the channel using a prioritized EDCA parameter set.

In some embodiments, if a STA encounters large packet drops due to latency requirement getting exceeded, then the STA can make a request to the AP and the AP can authorize the STA for priority access operation.

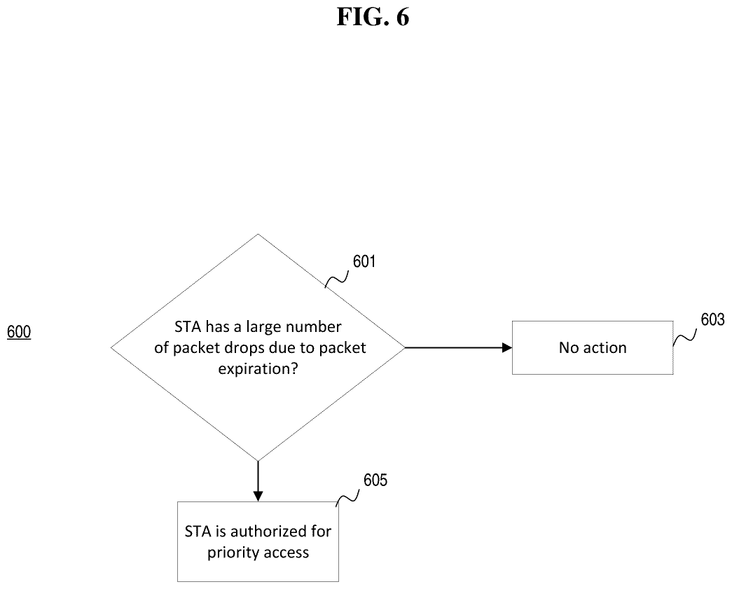

FIG. 6 illustrates a flow chart of an example process by a STA for packet drop based priority access authorization in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 6 illustrates operations performed in a STA, such as the STA illustrated in FIG. 3.

The process 600, in operation 601, the STA determines whether it faces a large number of packet drops due to packet expiration. In some embodiments, a packet drop may occur when a frame expires prior to the STA obtaining channel access. If the STA determines that it does not faces a large number of packet drops due to packet expiration, the process proceeds to operation 603 and the STA performs no action. If the STA determines that it does face a large number of packet drops due to packet expiration, the process proceeds to operation 605.

In operation 605, the STA requests and receives authorization from the AP for priority access. Accordingly, the STA may use a prioritized EDCA parameter set to contend for the channel.

In some embodiments, the STA can make a request to the AP for priority access. In some embodiments, the STA can transmit a priority access enable request message to the AP. The request message can include at least one or more of the information items as shown in Table 1.

Table 1 illustrates information items that can be present in the priority access enable request message in accordance with an embodiment.

TABLE 1

| Information | |
|---|---|
| item | Description |
| QoS | An information item that can describe the QoS requirements |
| requirements | of the requesting device. e.g., QoS characteristics |
| | information element (IE). |
| Request | An information item that can indicate that the device is |
| indication | making a request for getting priority access. e.g., reason |
| | code. |
| Request | An information item that can identify the request. e.g., |
| identifier | dialog token. |
| Link | An information item that can indicate the link for which this |
| indication | priority access is being requested. e.g., link ID, link ID |
| | bitmap, among others. |

The above information items can be transmitted together or separately. They can be transmitted as a part of any existing frame, element, field, or subfield in the standard or can be a part of newly defined ones.

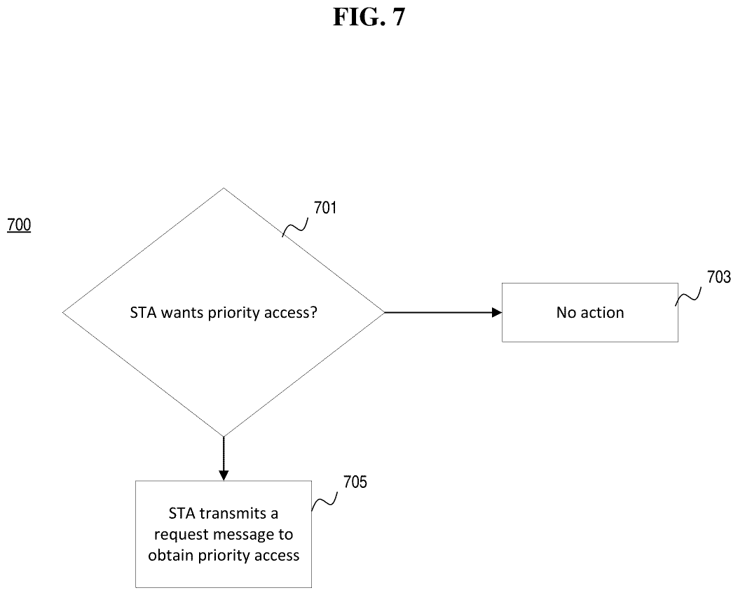

FIG. 7 illustrates a flow chart of an example process by a STA for priority access enable request in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 7 illustrates operations performed in a STA, such as the STA illustrated in FIG. 3.

The process 700, in operation 701, the STA determines whether the STA wants priority access. In some embodiments, the STA may determine whether it wants priority access based on the traffic characteristics of frames being communicated with the STA, in particular, if the STA has LL frames, then the STA may want priority access. In some embodiments, the STA may determine that it wants priority access based on the types of applications running on the STA. For example, applications with low latency requirements, among other types of application. If the STA determines that it does not want priority access, the process proceeds to operation 703 and the STA performs no action. If the STA determines that it does want priority access, the process proceeds to operation 705.

In operation 705, the STA transmits a request message to the AP to enable priority access. Accordingly, once the priority access is authorized by the AP, the STA may use a prioritized EDCA parameter set to contend for a channel.

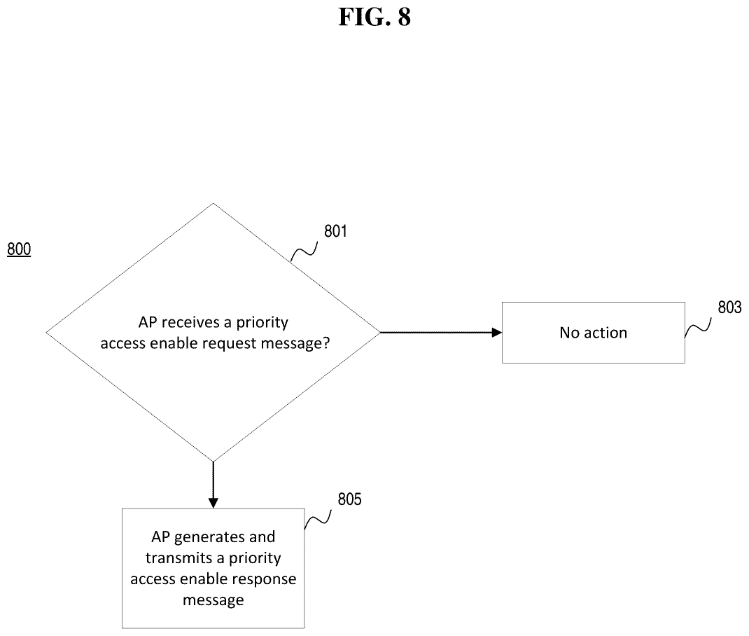

FIG. 8 illustrates a flow chart of an example process for priority access enable response in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 8 illustrates operations performed in a AP, such as the AP illustrated in FIG. 3.

The process 800, in operation 801, the AP determines whether it receives a priority access enable request message from an STA. If the AP determine that it does not receive a priority access enable request message from an STA, the process proceeds to operation 803 and performs no action. If the AP determine that it does receive a priority access enable request message from an STA, the process proceeds to operation 805.

In operation 805, the AP transmits to the STA a priority access enable response message. In some embodiments, the AP may grant an STA's request for priority access based on a type of traffic of the STA, QOS information setup with the STA, among other information. In some embodiments, the response message can include at least one or more of the information items as shown in Table 2.

Table 2 illustrates information items that can be present in the response message in accordance with an embodiment.

TABLE 2

| Information | |
|---|---|
| items | Description |
| Response | An information item that can indicate the response of the |
| indication | authorizing entity. e.g., status code. |
| Request | An information item that can indicate the request to which |
| indication | the response corresponds to. e.g., dialog token of the |
| | request. |
| Prioritized | An information item that can carry the prioritized EDCA |
| EDCA | parameter set if authorization has been provided. |
| parameter set | |
| Link | An information item that can indicate the link for which the |
| indication | authorization has been provided. e.g., link ID, link ID |
| | bitmap, among others. |

The above information items can be transmitted together or separately. They can be transmitted as a part of any existing frame, element, field, or subfield in the standard or can be a part of newly defined ones.

In some embodiments, upon receiving the response, the authorized entity can update its EDCA parameters as soon as possible in implementation and start to use the prioritized EDCA parameter set.

In some embodiments, an authorization can be provided in a solicited or an unsolicited manner. In some embodiments, the AP can assess that a particular STA's traffic is facing a large number of packet drops due to expiration timer getting exceeded and can authorize the STA in an unsolicited manner.

In some embodiments, a prioritized EDCA parameter set that the AP has provided to the STA can become stale over a period of time and may not provide the same level of priority access as necessary. In such a situation, the AP can update the prioritized EDCA parameter set upon request or in an unsolicited manner. The AP can transmit an unsolicited update message to the STA to request the STA to update its prioritized EDCA parameter set. The message can include at least one or more of the information items as indicated in Table 2 and can additionally include a reason information item that can indicate that the reason for transmitting the frame is to update the EDCA parameters (e.g., by using a reason code).

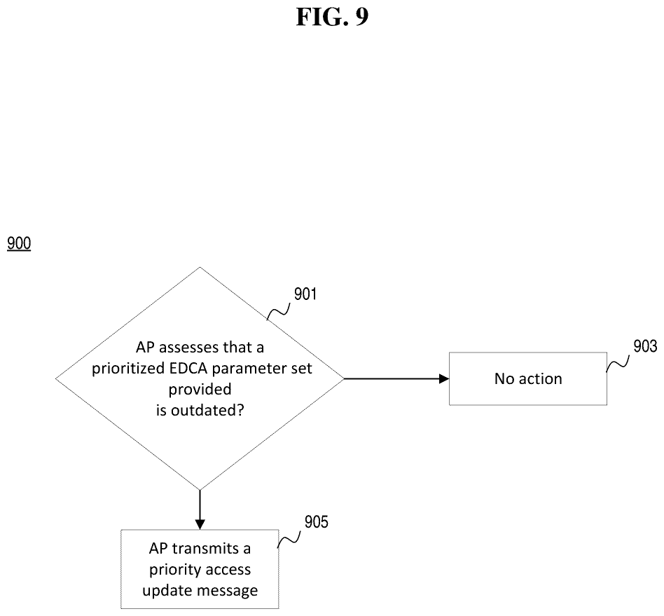

FIG. 9 illustrates a flow chart of an example process by an AP for priority access update in accordance with an embodiment. In some embodiments, an STA can also make a request for the update from the AP. Although one or more operations are described or shown in a particular sequential order, in other embodiments the operations may be rearranged in a different order, which may include performance of multiple operations in at least partially overlapping time periods. The flowchart depicted in FIG. 9 illustrates operations performed in a AP, such as the AP illustrated in FIG. 3.

The process 900, in operation 901, the AP determines whether a prioritized EDCA parameter set that has been provided is stale or needs to be updated. In some embodiments, the AP may determine that a same level of priority is no longer necessary for the STA. For example, the STA may no longer be transmitting and/or receiving low latency frames or the STA is no longer executing a low latency application. If the AP determines that a prioritized EDCA parameter set that has been provided is not stale or does not need to be updated, the process proceeds to operation 903 and the AP performs no action. If the AP determines that a prioritized EDCA parameter set that has been provided is stale and needs to be updated, the process proceeds to operation 905.

In operation 905, the AP transmits to an STA a priority access update message. In some embodiments, the priority access update message may include a normal EDCA parameter set that the STA should begin to use. In some embodiments, the AP or STA can terminate the priority access by transmitting a priority access termination message. The message can include at least one or more of the information items as shown in Table 3.

Table 3 illustrates information items that can be present in a termination message in accordance with an embodiment.

TABLE 3

| Information | |
|---|---|
| item | Description |
| Request | An information item that can describe the request to which |
| indication | the termination corresponds to. e.g., dialog token of the |
| | request. |
| Reason | An information item that can indicate the reason for the |
| indication | termination. e.g., reason code. |

The above information items can be transmitted together or separately. They can be transmitted as a part of any existing frame, element, field, or subfield in the standard or can be a part of newly defined ones.

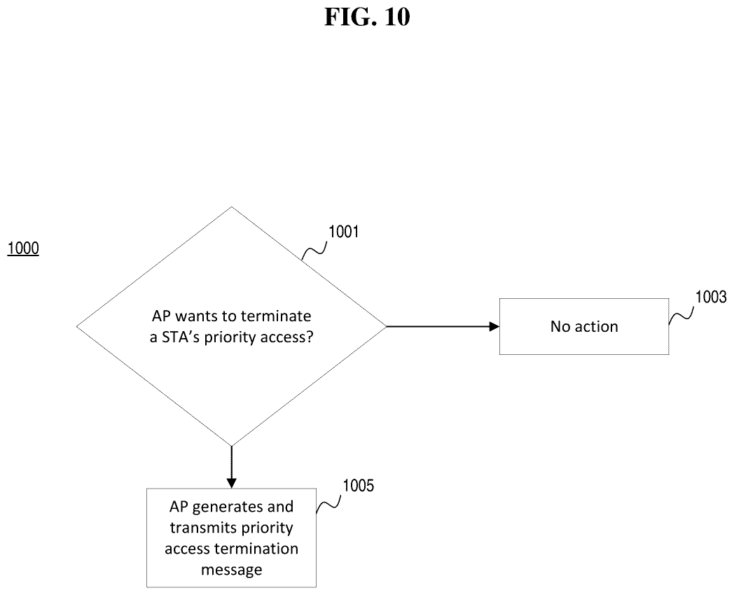

FIG. 10 illustrates a flow chart of an example process by an AP for priority access termination in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a AP, such as the AP illustrated in FIG. 3.

The process 1000, in operation 1001, the AP determines whether the AP wants to terminate a STA's priority access. In some embodiments, the AP may determine to terminate the STA's priority access if the STA is no longer handling LL traffic. In some embodiments, an AP may terminate a STA's priority access if the STA is no longer executing a LL application, among other factors. If the AP determines that the AP does not want to terminate a STA's priority access, the process proceeds to operation 1003 and the AP performs no action. If the AP determines that the AP wants to terminate a STA's priority access, the process proceeds to operation 1005.

In operation 1005, the AP transmits to the STA a priority access termination message. In some embodiments, the AP can terminate the authorization in a number of situations. In some embodiments, if the AP determines that the STA is misusing its authorization, the AP can terminate the STA's authorization. In some embodiments, if the AP determines that the STA no longer needs priority access and the current channel access delay can be tolerated by the STA's traffic, then the AP can terminate the STA's priority access authorization.

In some embodiments, an authorizing entity can be any device and is not limited to the AP (e.g., P2P group owner, among others). In some embodiments, the requesting entity can be any device and is not limited to the STA.

In some embodiments, a low-latency (LL) session can be established and managed via a Stream Classification Service (SCS) setup.

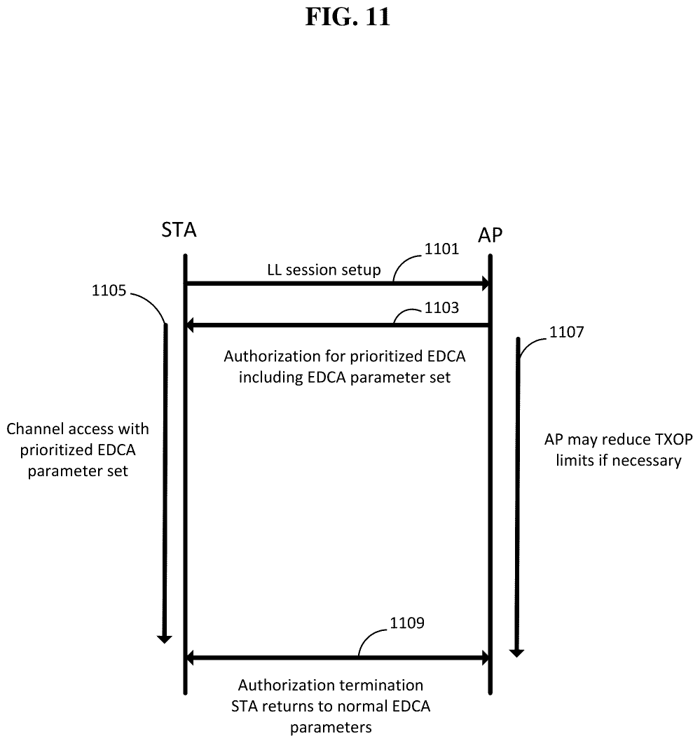

FIG. 11 illustrates a SCS setup in accordance with an embodiment. In particular, FIG. 11 illustrates communication between a STA and an AP. The STA transmits a request message 1101 to the AP for a LL session setup. The request message may include one or more of the information items including an information item that describes QoS requirements of the STA, an information item that can identify the request (e.g., dialog token), and an information item that can indicate the link for which priority access is being requested (e.g., link ID, link ID bitmap, among others).

The AP transmits an authorization response message 1103 to the STA which authorizes the STA for prioritized EDCA and includes a new prioritized EDCA parameter set. Accordingly, the STA can perform channel access with the prioritized EDCA parameter set 1105. The AP can reduce TXOP limits 1107 if necessary. The AP can transmit to the STA an authorization termination message 1109 whereby the STA returns to a normal EDCA parameter set.

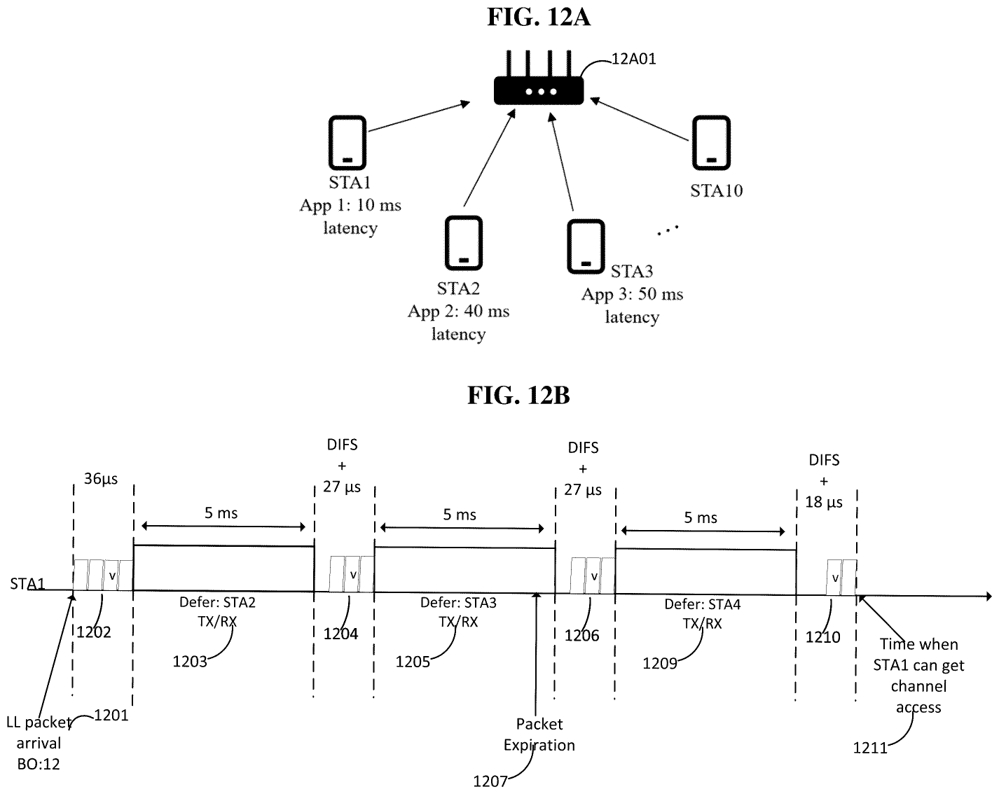

FIG. 12A illustrates an example topology with packet latency requirements in accordance with an embodiment. In particular, FIG. 12A illustrates an AP 12A01 communicating with STA1, STA2, STA3 to STA10. STA1 has an application that has traffic with a 10 ms latency requirement (e.g., the LL packets will expire after 10 ms), STA2 has an application with a 40 ms latency requirement, STA3 has an application with a 50 ms latency requirement. Accordingly, STA1 may need have the lowest latency frames of the various STAs and thus may need to obtain channel access the quickest in order to not drop any of the packets (e.g., as a result of a packet expiration).

Accordingly, FIG. 12B illustrates an example of a packet expiration that may occur prior to an LL session setup in accordance with an embodiment. In particular, a LL packet arrival 1201 at STA1. The packet may have a latency requirement of 10 ms. However, after counting down 4 slots 1202, STA1 has to defer to STA2 1203. An interframe space (IFS) is a period of time a STA waits before transmitting a frame to avoid collisions and to implement priority systems, with shorter IFS times indicating higher priority. As illustrated, after a Distributed Coordination Function (DCF) Interframe Spacing (DIFS) where STA1 counts down three slots 1204, STA1 has to again defer to STA3 1205, during this time the LL packet expires 1207. After a DIFS where STA1 has to count down from three slots 1206, STA1 has to again defer to STA4 1209. After a DIFS where STA1 counts down from two slots 1210, STA1 can now obtain channel access at the indicated time 1211, however this is after the packet expiration time 1207 (e.g., about 10 ms).

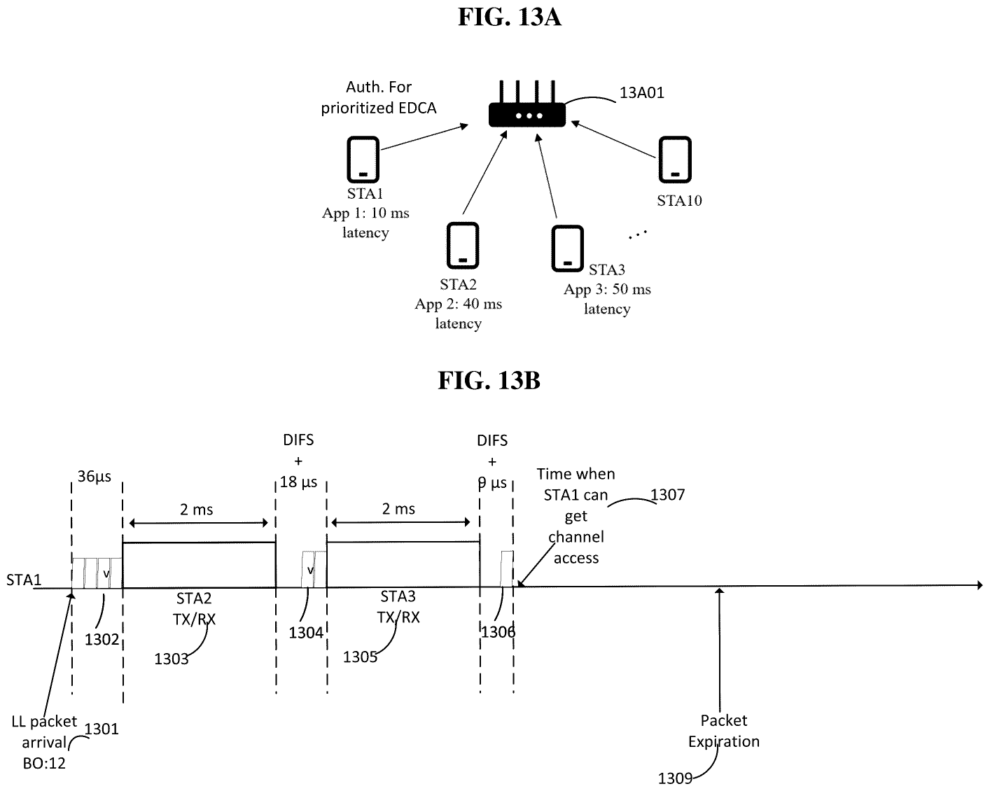

FIG. 13A illustrates an example where STA1 has obtained authorization for prioritized EDCA. In particular, FIG. 13A illustrates an AP 13A01 communicating with STA1, STA2, STA3, to STA10. Similar to FIG. 12A, STA1 has an application that has traffic with a 10 ms latency requirement (e.g., the LL packets will expire after 10 ms), STA2 has an application with a 40 ms latency requirement, STA3 has an application with a 50 ms latency requirement. Accordingly, STA1 may need have the lowest latency frames of the various STAs and thus may need to obtain channel access the quickest in order to not drop any of the packets (e.g., as a result of a packet expiration). Accordingly, STA1 has been authorized by the AP for prioritized EDCA.

FIG. 13B illustrates an example of packet transmission (without packet expiration) after an LL session setup in accordance with an embodiment. In this example, STA1 has been authorized for prioritized access using a prioritized EDCA parameter set. Accordingly, STA1 receives a LL packet at the indicated LL packet arrival time 1301. After a DIFS where STA1 counts down four slots 1302, STA1 defers to STA2 1303, after another DIFS where STA1 counts down two slots 1304, STA1 defers to STA3 1305. After another DIFS where STA1 counts down 1 slot 1306, illustrated at time 1307, STA1 obtains channel access whereby STA1 can transmit the LL frame, which is prior to the indicated packet expiration time 1309.

In some embodiments, when there is a conflict (e.g., Emergency Preparedness Communication Service (EPCS) device in the network), the AP can deauthorize the STA for use of prioritized EDCA parameter set.

In certain embodiments, the AP can also change the EDCA parameters to provide higher priority to EPCS devices. In some embodiments, the AP can provide prioritized EDCA parameters to the EPCS device that can provide higher priority to it over the LL STA.

In some embodiments, the AP can control the Access Category (AC) that the STA's traffic gets mapped to. For example, the AP can inform the STA to map its best effort traffic to voice queue to provide prioritization.

In some embodiments, in order to meet voice and video stream requirements over an IEEE 802.11 WLAN, support for quality of service traffic which was introduced by the IEEE 802.11e and adopted in later standards provides differentiated channel access to frames belonging to different priorities. This feature considers eight different user priorities and four access categories (ACs) which may be derived from these user priorities for traffic stream prioritization. The four access categories which are supported are background (AC_BK), best effort (AC_BE), video (AC_VI) and voice (AC_VO).

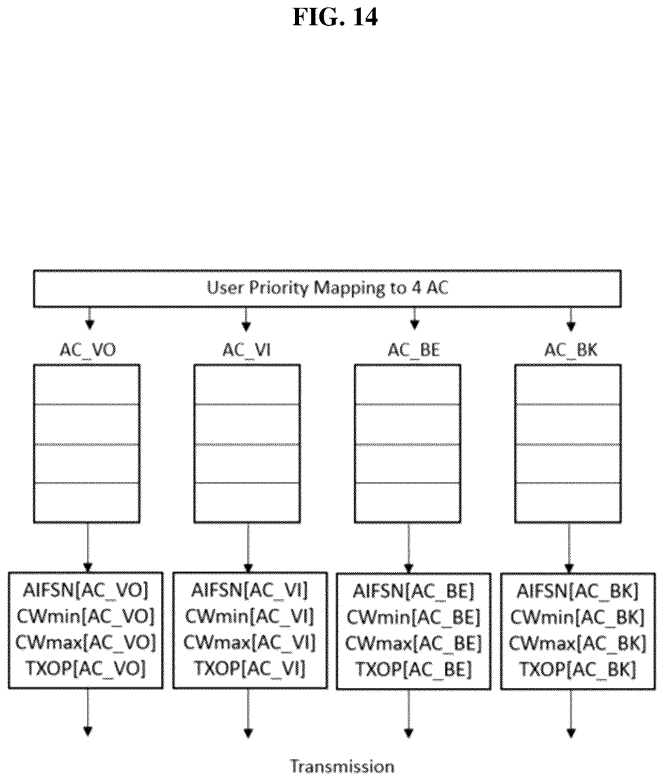

FIG. 14 illustrates an EDCA parameter set that specifies parameters for each AC queue in accordance with an embodiment. As shown in FIG. 14, this feature considers an individual transmission queue for each AC, including AC_VO, AC_VI, AC_BE, and AC_BK, wherein each queue behaves as an individual contending entity characterized by its own EDCA parameter set. In some embodiments, the priority level is specified in the EDCA parameter set by leveraging a min and max value for contention window (CW), an Arbitration Inter-Frame Spacing (AIFSN) value and a Transmission Opportunity (TXOP) limit. When a particular AC completes its backoff and gains channel access, the STA can perform data transmission for an amount of time that is upper bounded by transmit opportunity (TXOP). By providing a larger TXOP value for AC_VI and AC_VO, the standard intends to increase the throughput of high priority data such as voice and video.

A summary of the EDCA parameter set element parameter values is shown in Table 4.

TABLE 4

| | | | | TXOP limit | | | | |
|---|---|---|---|---|---|---|---|---|
| | | | | | For PHYs | | | |
| | | | | | defined in | | | |
| | | | | For PHYs | Clause 17, | | | |
| | | | | defined in | Clause 18, | For PHY | | |
| | | | | Clause 15 and | Clause 19, and | defined in | | Other |
| AC | CWmin | CWmax | AIFSN | Clause 16 | Clause 21 | Clause 22 | Clause 23 | PHYs |
| AC_BK | aCWmin | aCWmax | 7 | 3.264 ms | 2.528 ms | 0 | 15.008 ms | 0 |
| AC_BE | aCWmin | aCWmax | 3 | 3.264 ms | 2.528 ms | 0 | 15.008 ms | 0 |
| AC_VI | (aCWmin + 1)/ | aCWmin | 2 | 6.016 ms | 4.096 ms | 22.56 ms | 15.008 ms | 0 |
| | 2 − 1 | | | | | (BCU: 6 or | | |
| | | | | | | 7 MHz), | | |
| | | | | | | 16.92 ms | | |
| | | | | | | (BCU: | | |
| | | | | | | 8 MHz) | | |
| AC_VO | (aCWmin + 1)/ | (aCWmin + 1)/ | 2 | 3.264 ms | 2.080 ms | 11.28 ms | 15.008 ms | 0 |
| | 4 − 1 | 2 − 1 | | | | (BCU: 6 or | | |
| | | | | | | 7 MHz), | | |
| | | | | | | 8.46 ms | | |
| | | | | | | (BCU: | | |
| | | | | | | 8 MHz) | | |

As provided in Table 4, except for the case of clause 23 which is for supporting operation in TV white spaces (TVWS) spectrum in VHF and UHF bands between 54 and 790 MHz, the four ACs have different TXOP value. Clause 22 which indicates the values introduced in IEEE 802.11ac and later adopted in following standard documents, assigns a value of 0 for the TXOP limit for AC_BK and AC_BE. This value of 0 indicates that each channel access for these categories can result in transmission of only a single frame. However, to support higher throughput for video and voice data, the AC_VO and AC_VI have been assigned much higher values for TXOP limit. Consequently, for these access categories when a STA obtains channel access, it can transmit as many aggregated frames as possible while staying within the TXOP limit. Support for QoS traffic has been adopted in IEEE 802.11be as well.

In some embodiments, EDCA based prioritization can be used. In some embodiments, the EDCA parameter set used by a STA can be enhanced or prioritized to provide support for the low latency application running on the STA. As described herein, the EDCA parameter set that can reduce the channel access compared to the legacy channel access can be referred to as the prioritized EDCA parameter set or the enhanced EDCA parameter set. The EDCA parameter set that the STA can use when not using the prioritized EDCA parameter set can be referred to as normal EDCA parameter set.

In some embodiments, the prioritized EDCA parameter set can include at least one or more of the items as listed for one or more of the AC: including 1) CWmin, 2 CWmax, 3) AIFSN and/or 4) TXOP limit.

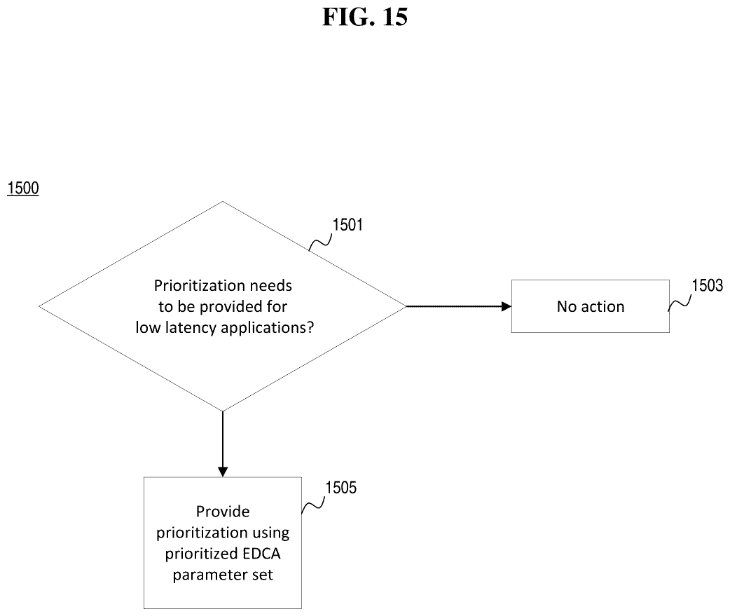

FIG. 15 illustrates a flow chart of an example process for EDCA parameter set enhancement in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 15 illustrates operations performed in a STA, such as the STA illustrated in FIG. 3.

The process 1500, in operation 1501, the STA determines whether prioritization or prioritized access needs to be provided for low latency application. If the STA determines that prioritization does not need to be provided for a low latency application, the process proceeds to operation 1503 and the STA performs no action. If the STA determines that prioritization does need to be provided for a low latency application, the process proceeds to operation 1505.

In operation 1505, the STA provides prioritization to the low latency application using a prioritized EDCA parameter set. Accordingly, the STA may prioritize channel access for the LL traffic associated with eh LL applications.

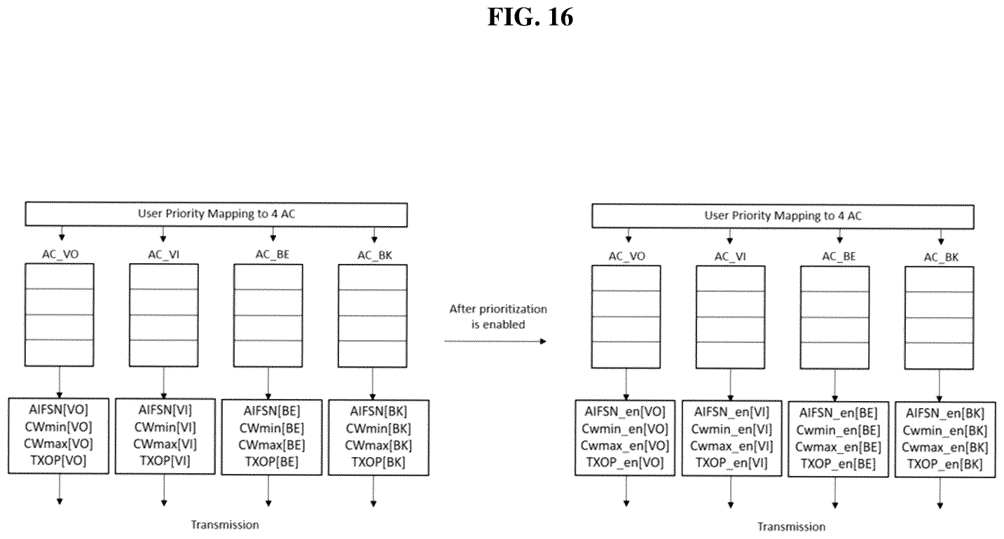

FIG. 16 illustrates an example of a prioritized EDCA parameter set in accordance with an embodiment. In some embodiments, STA is provided with a prioritized EDCA parameter set that changes the normal EDCA parameter values that the STA uses. The prioritized EDCA parameter set may change one or more (e.g., all) the EDCA parameter values that are used by the STA. As illustrated, for each AC, including AC_VO, AC_VI, AC_BE, and AC_BK, the normal parameter values, including AIFSN, CWmin, CWmax, TXOP, are changed after priorization is enabled to enhanced values, including AIFSN_en, Cwmin_en, Cwmax_en, and TXOP_en.

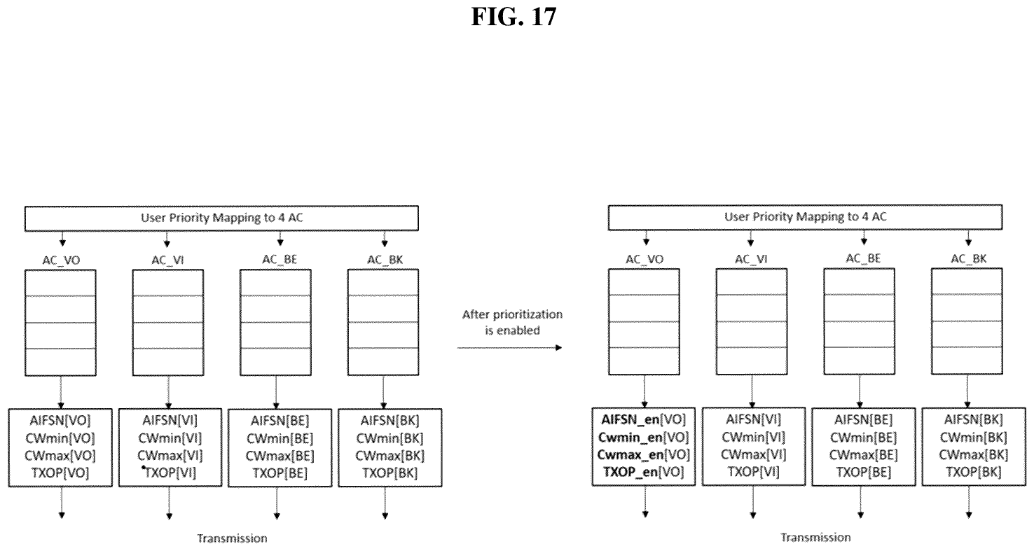

FIG. 17 illustrates another example of a prioritized EDCA parameter set in accordance with an embodiment. In some embodiments, STA is provided with a prioritized EDCA parameter set that changes the normal EDCA parameter values that the STA uses. In some embodiments, the prioritized EDCA parameter set does not change all the normal EDCA parameter values that the STA uses. In some embodiments, only the EDCA parameter values that are updated may be used and the remaining EDCA parameter values may be the same. As illustrated in FIG. 17, only the EDCA parameter values for AC_VO are updated to the enhanced values after prioritization is enabled, including AIFSN_en, Cwmin_en, Cwmax_en, and TXOP_en, while the other ACs, including AC_VI, AC_BE, and AC_BK do not change.

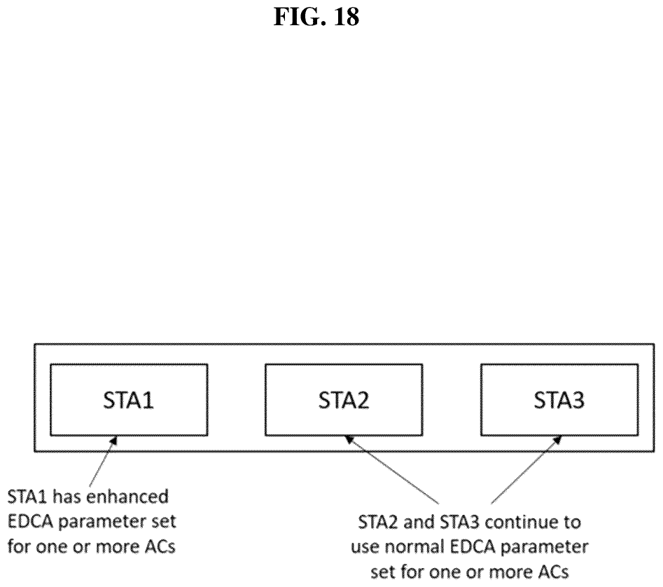

FIG. 18 illustrates an example of a multi-link device (MLD) with prioritized EDCA parameter set and normal parameter set in accordance with an embodiment. In particular, the MLD is affiliated with STA1, STA2 and STA3. As illustrated, STA1 is provided with an enhanced or prioritized EDCA parameter set that changes the normal EDCA parameter values that the STA1 uses for one or more ACs. But one or more of the other STAs of the MLD, including STA2 and STA3 that are affiliated with the same MLD continue to use the normal EDCA parameter values for one or more ACs. Accordingly, an MLD may have certain STAs that are able to use a prioritized EDCA parameter set and other STAs that may have to use a normal EDCA parameter set.

In some embodiments, the STA that receives prioritized EDCA parameter set can make use of the EDCA parameter set for transmission of specific frame(s). These frames can be frames that belong to low latency traffic stream (e.g., as indicated by traffic classification (TCLAS) and TCLAS processing element in the SCS setup procedure). In some embodiments, when the STA is contending to access the channel for frame(s) belonging to a low latency traffic stream, the STA can use the prioritized EDCA parameters. Otherwise, the STA can use the normal EDCA parameters.

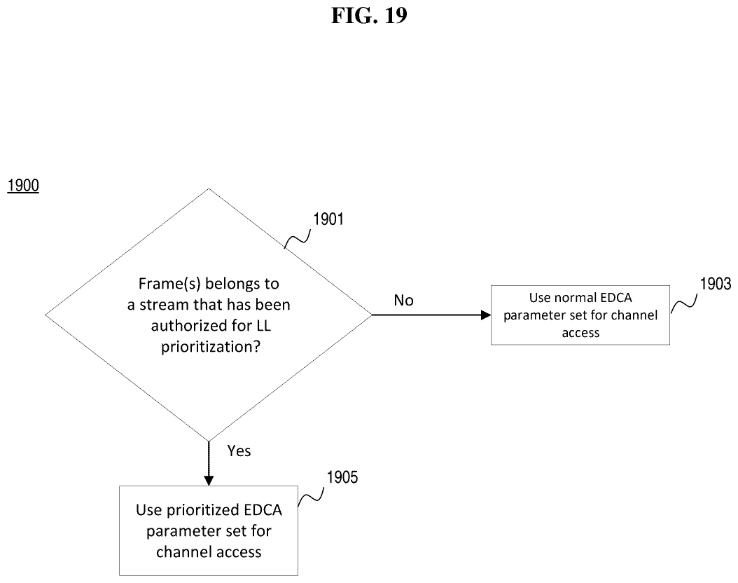

FIG. 19 illustrates a flow chart of an example process by a STA for using prioritized EDCA for channel access in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 19 illustrates operations performed in a STA, such as the STA illustrated in FIG. 3.

The process 1900, in operation 1901, the STA determines whether one or more frames belong to a stream that has been authorized for low latency prioritization. In some embodiments, the stream may be associated with a low latency application that includes low latency frames.

If the STA determines that one or more frames do not belong to a stream that has been authorized for low latency prioritization, the process proceeds to operation 1903 where the STA uses a normal EDCA parameter set for channel access. If the STA determines that one or more frames do belong to a stream that has been authorized for low latency prioritization, the process proceeds to operation 1905.

In operation 1905, the STA uses a prioritized EDCA parameter set for channel access. The prioritized EDCA parameter set can include one or more enhanced values for a AIFSN value, CWmin value, CWmax value, and a TXOP value, among others.

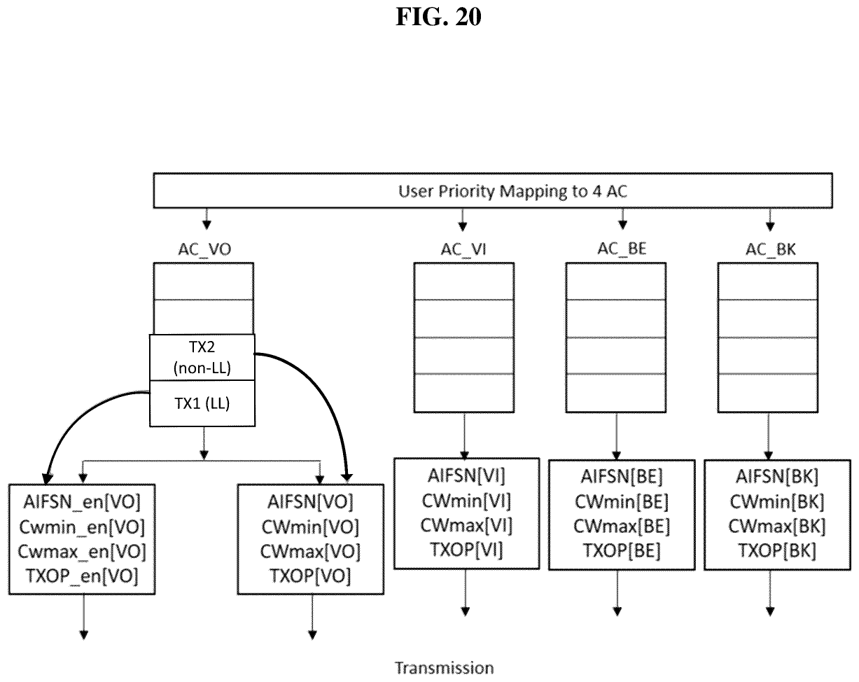

FIG. 20 illustrates an example operation of transmit level enhancement in accordance with an embodiment. In some embodiments, the STA that receives a prioritized EDCA parameter set can make use of prioritized EDCA parameter set for a given AC for all the frame(s) that are mapped to that AC. As illustrated in FIG. 20, AC_VO includes TX1 LL which is a LL transmission that uses the prioritized EDCA parameter set (enhanced values for AIFSN, CWmin, CWmax, and TXOP) and TX2 which is a non-LL transmission that uses the normal EDCA parameter set (normal values for AIFSN, CWmin, CWmax, and TXOP). The remaining ACs, including AC_VI, AC_BE, and AC_BK all use the normal EDCA parameter set.

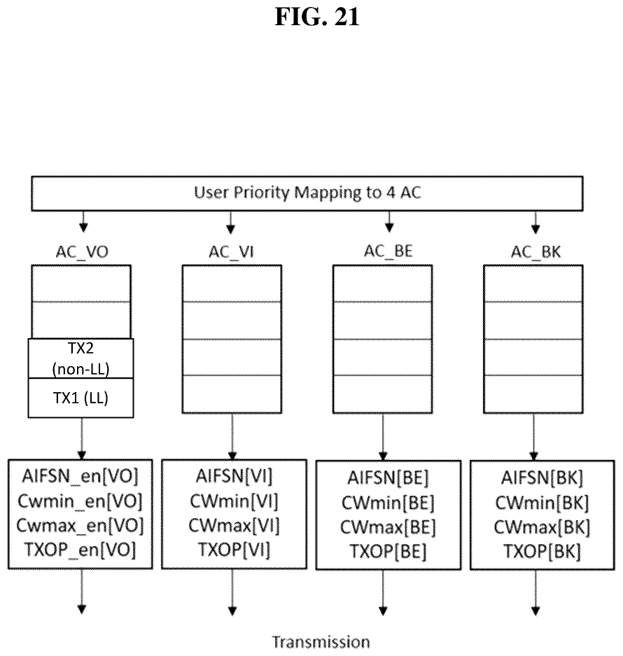

FIG. 21 illustrates an example operation of AC level enhancement in accordance with an embodiment. As illustrated, AC_VO includes TX1 which is a LL transmission and TX2 which is a non-LL transmission, however, both transmission are provided with the prioritized EDCA parameter set (enhanced values for AIFSN, CWmin, CWmax, and TXOP), while the other ACs, including AC_VI, AC_BE, and AC_BK operate with the normal EDCA parameter set.

In some embodiments, a Media Access Control (MAC) queue based enhancement can be used for prioritization. In some embodiments, a special LL queue can be created for LL traffic. The LL traffic queue can be provided with prioritized EDCA parameters. The remaining AC can continue to use the normal EDCA parameters. Frame(s) of the LL traffic stream that have been authorized for prioritization can be routed to the new queue.

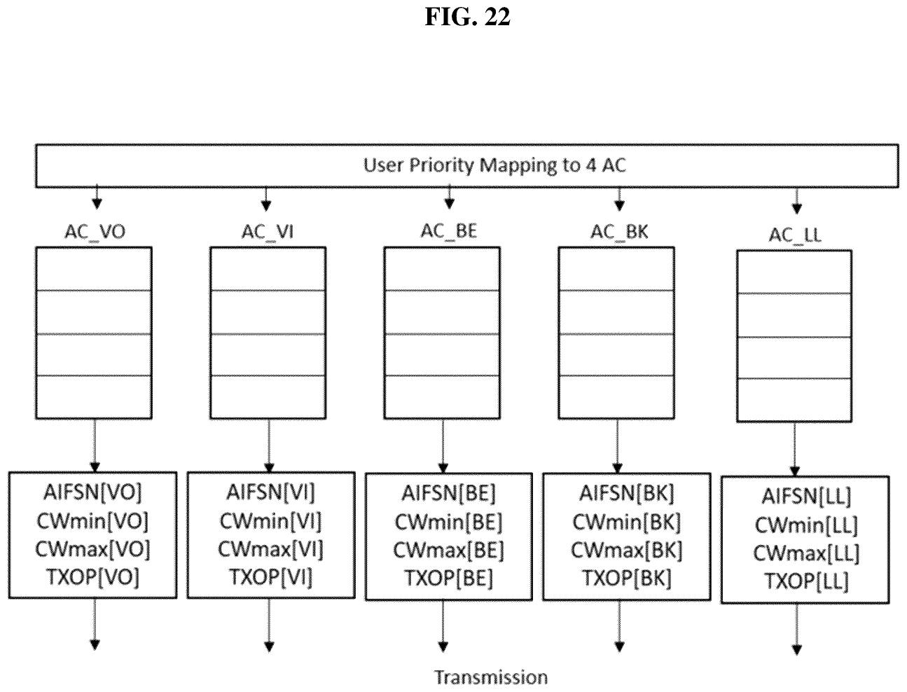

FIG. 22 illustrates a MAC queue management based prioritization in accordance with an embodiment. As illustrated, the ACs include AC_VO, AC_VI, AC_BE, AC_BK, and AC_LL. The AC_LL traffic queue can be provided with the prioritized EDCA parameter set (AIFSN[LL], Cwmin[LL], Cwmax[LL], TXOP[LL]) while the remaining ACs, including AC_VO, AC_VI, AC_BE, and AC_BK can use the normal EDCA parameters (normal values for AIFSN, CWmin, CWmax, and TXOP).

In some embodiments, there can be more than one LL traffic stream. In such a scenario, the authorized LL streams can have individual queues.

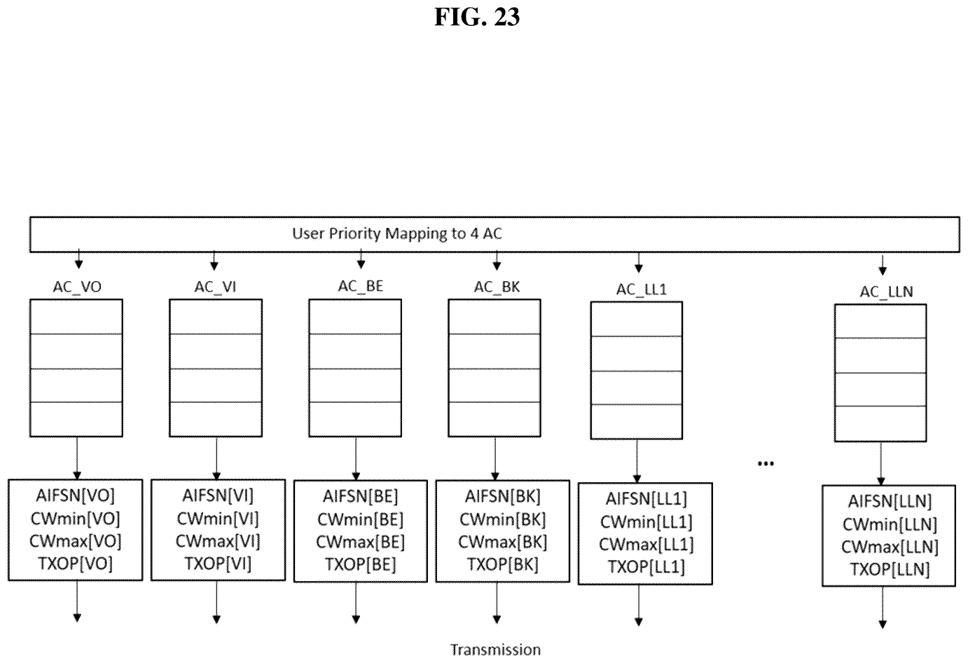

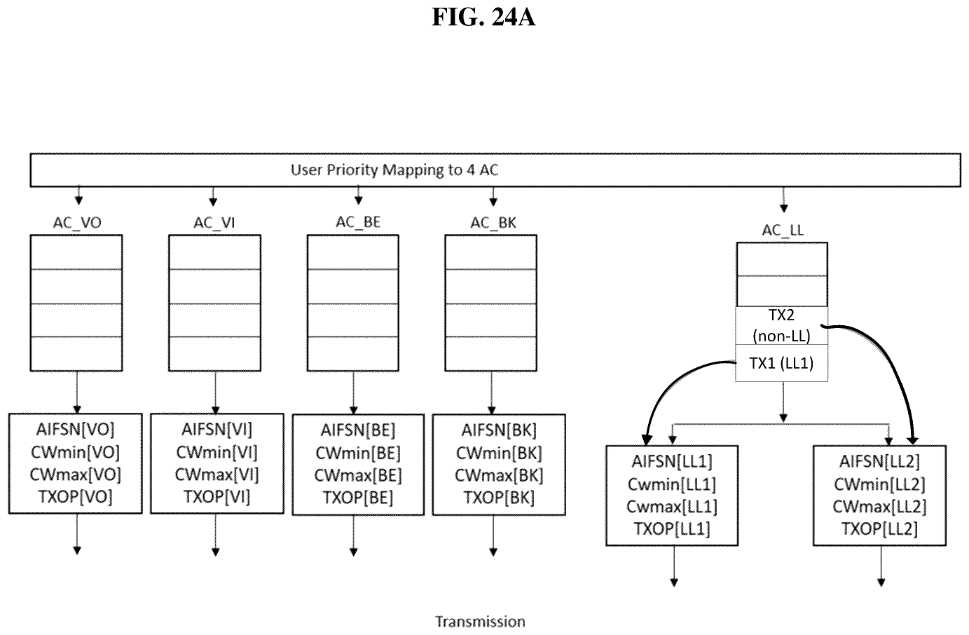

FIG. 23 illustrates LL stream individual queues in accordance with an embodiment. As illustrated, the AC queues including AC_VO, AC_VI, AC_BE, AC_BK, as well as low latency queues AC_LL1 to AC_LLN, which can transmit using the prioritized EDCA parameter set (AIFSN[LL1], Cwmin[LL1], Cwmax[LL1], TXOP[LL1]) to ((AIFSN[LLN], Cwmin[LLN], Cwmax[LLN], TXOP[LLN]). The remaining ACs, including AC_VO, AC_VI, AC_BE, and AC_BK can use the normal EDCA parameters (normal values for AIFSN, CWmin, CWmax, and TXOP).

In some embodiments, there can be a single LL traffic stream. This LL queue can either have the prioritized EDCA parameter of the lowest latency stream or can have one or more prioritized EDCA parameter sets that it can switch between based on the frame(s) to transmit.

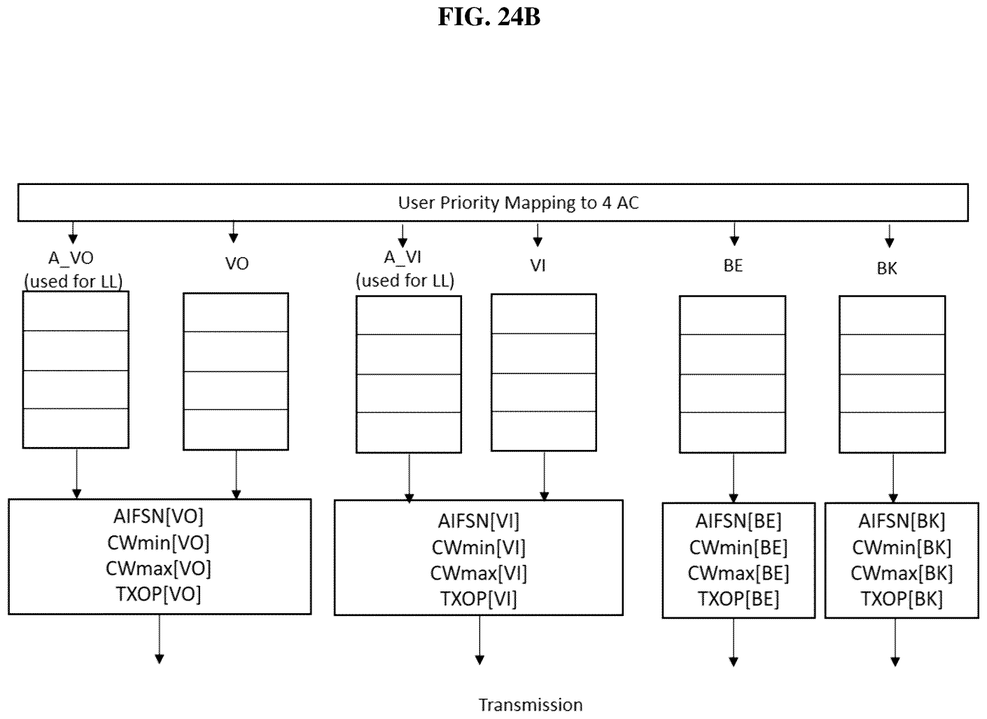

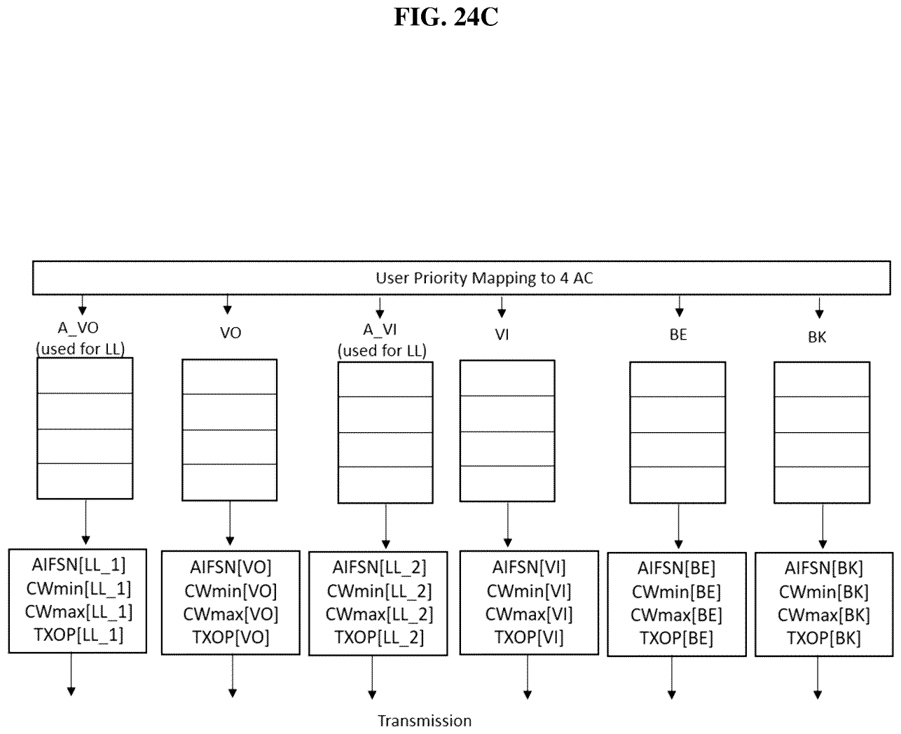

FIG. 24A illustrates a single LL stream queue with multiple prioritized EDCA parameter set in accordance with an embodiment. In particular, FIG. 24 illustrates AC queues including AC_VO, AC_VI, AC_BE, AC_BK, as well as low latency queue AC_LL. The AC_LL queue includes TX1 LL frame that is transmitted with a first prioritized EDCA parameter set (AIFSN[LL1], Cwmin[LL1], Cwmax[LL1], TXOP[LL1]), and a TX2 LL2 frame that is transmitted with a second prioritized EDCA parameter set (AIFSN[LL2], Cwmin[LL2], Cwmax[LL2], TXOP[LL2]). The remaining ACs, including AC_VO, AC_VI, AC_BE, and AC_BK can use the normal EDCA parameter set (normal values for AIFSN, CWmin, CWmax, and TXOP).

FIG. 24B illustrates alternative queues that include LL traffic and normal traffic for a particular, AC in accordance with an embodiment. In particular, FIG. 24B illustrates the access category VO having an alternative queue for LL traffic, A_VO, and a normal VO queue for normal traffic, as well as the access category VI having an alternative queue for A_VI LL traffic and a normal queue for normal VI traffic. The various EDCA parameter sets for the various ACs are also illustrated.

FIG. 24C illustrates alternative queues that include LL traffic and normal traffic, each having a set of EDCA parameters, for an AC in accordance with an embodiment. In particular, FIG. 24B illustrates the access category VO having an alternative queue for LL traffic, A_VO, which has a prioritized set of EDCA parameters (AIFSN[LL_]1, CWmin[LL_1], CWmax[LL_1], and TXOP[LL_1]. The queues also include a normal VO queue with normal EDCA parameters AIFSN[VO], CWmin[VO], CWmax[VO], and TXOP[VO]. There is also an alternative queue for A_VI LL traffic with prioritized EDCA parameters (AIFSN[LL_2], CWmin[LL_2], CWmax[LL_2], and TXOP[LL_2]), and a normal queue for VI traffic with normal EDCA parameters (AIFSN[VI], CWmin[VI], CWmax[VI], and TXOP[VI]). The remaining queues BE and BK have normal EDCA parameters.

In some embodiments, instead of enhancing the EDCA parameters of an STA (e.g., STA1), the EDCA parameters of other STAs (e.g., STA2) can be degraded. This can result in the authorized STA (STA1) to gain faster channel access compared to other non-authorized STAs (STA2) in the network.

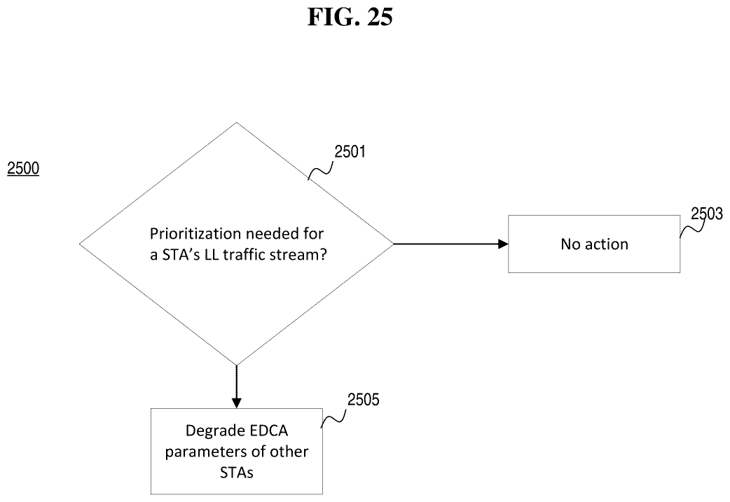

FIG. 25 illustrates a flow chart of an example process for degradation based prioritization in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 25 illustrates operations performed in a AP, such as the AP illustrated in FIG. 3.

The process 2500, in operation 2501, the AP determines whether prioritization is needed for a STA's LL traffic stream. If the AP determines that prioritization is not needed for a STA's LL traffic stream, the process proceeds to operation 2503 and the AP performs no action. If the AP determines that prioritization is needed for a STA's LL traffic stream, the process proceeds to operation 2505.

In operation 2505, the AP can degrade the EDCA parameter set of one or more other STAs. In some embodiments, degrading the EDCA parameter set can include using weaker values for one or more of the AIFSN, CWmin, CWmax, and TXOP than the normal values, whereby contending for the channel and winning the channel is made probable in relation to using a normal EDCA parameter set to contend for the channel.

In some embodiments, upon a QoS setup, an AP can receive delay tolerance information of a STA's traffic stream. Based on the delay tolerance information (d), an AP can divide the traffic stream into three classes as follows.

Class A: d≤TXOP limit+Δ (where Δ is to account for deviations that are small compared to the TXOP limit). The Class A class of traffic streams can be those whose delay tolerance is small enough such that the frame(s) can expire within a TXOP limit. The problem encountered here can be that if the traffic arrives in the middle of a long TXOP, it can expire before the TXOP is completed.

Class B: TXOP limit<d≤one or few legacy channel access delays. Here legacy channel access delay can be defined as the time it takes for a legacy device to access the wireless medium. The device can be contending and can defer to a number of transmissions from other devices. The traffic stream's latency requirement may not be high enough to tolerate one or more than one channel access delays.

Class C: one or more legacy channel access delays<<d (d is finite). This class of traffic streams can be those whose delay tolerance is large enough for them to contend for the wireless medium with some help from the AP (e.g., triggering).

Class A handling in accordance with this disclosure is described herein. In some embodiments, when an AP has a class A traffic stream setup by the STA, the AP can authorize the STA to participate in a technique that allows for transmissions during an ongoing TXOP (e.g., TXOP level preemption). This can be done by the AP when the STA sets up a SCS session with the AP and provides a QoS characteristic information element (IE). The AP can provide this information to the STA explicitly in an authorization message. In some embodiments, the information can be implicitly understood by the STA based on the AP accepting its QoS request. A STA whose traffic stream is Class A can use the traffic stream treatment procedure for Class B and Class C traffic streams as well.

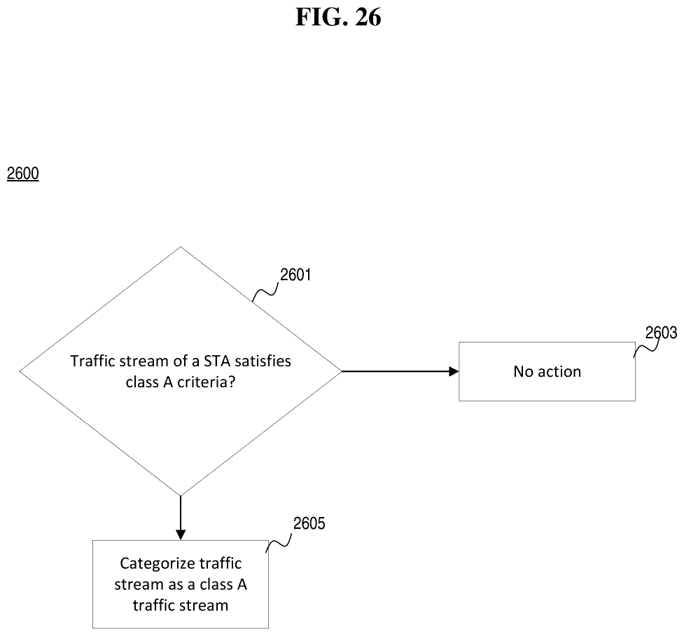

FIG. 26 illustrates a flow chart of an example process for class A authorization policy in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 26 illustrates operations performed in a AP, such as the AP illustrated in FIG. 3.

The process 2600, in operation 2601, the AP determines whether a traffic stream of a STA satisfies a class A criteria. In some embodiments, class A is a delay (d) that is less than a TXOP limit. In particular, the Class A class of traffic streams can be those whose delay tolerance is small enough such that the frame(s) can expire within a TXOP limit. If the AP determines that a traffic stream of a STA does not satisfy a class A criteria, the process proceeds to operation 2603 and performs no action. If the AP determines that a traffic stream of a STA satisfies a class A criteria, the process proceeds to operation 2605.

In operation 2605, the AP categorizes the traffic stream as a class A traffic stream.

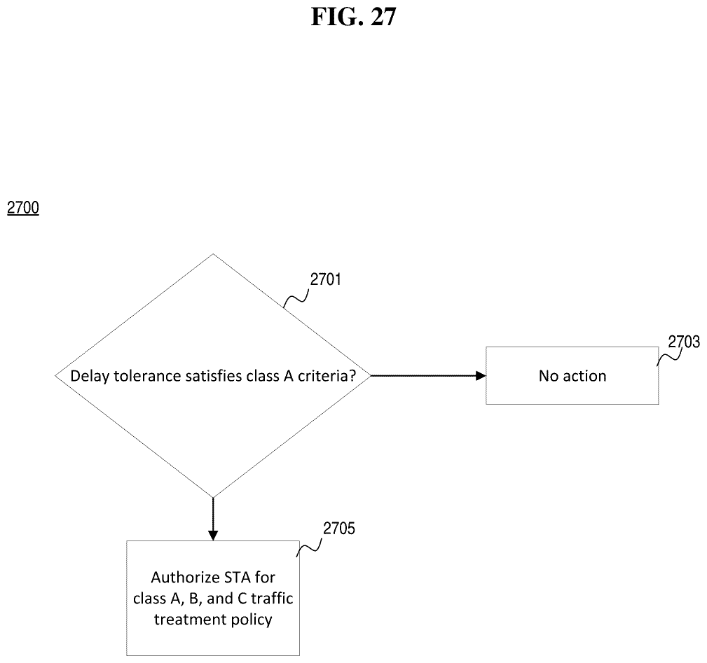

FIG. 27 illustrates a flow chart of an example process for a class A traffic treatment policy in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 27 illustrates operations performed in a AP, such as the AP illustrated in FIG. 3.

The process 2700, in operation 2701, the AP determines whether a delay tolerance of an STA satisfies a class A criteria. If the AP determines that a delay tolerance of a STA does not satisfy a class A criteria, the process proceeds to operation 2703 and performs no action. If the AP determines that a delay tolerance of a STA satisfies a class A criteria, the process proceeds to operation 2705.

In operation 2705, the AP authorizes the STA for class A, B and C traffic treatment policies.

Class B handling in accordance with this disclosure is described herein. In some embodiments, when an AP has a class B traffic stream setup by the STA, the AP can authorize the STA to participate in a technique that allows for faster channel access (e.g., priority channel access mechanism). The AP can provide this information to the STA explicitly in an authorization message or this can be implicitly understood by the STA based on the AP accepting its QoS request. In some embodiments, a STA whose traffic stream is Class B may not use the traffic stream treatment procedure for a Class A traffic stream but can use the traffic stream treatment procedure for Class C traffic stream.

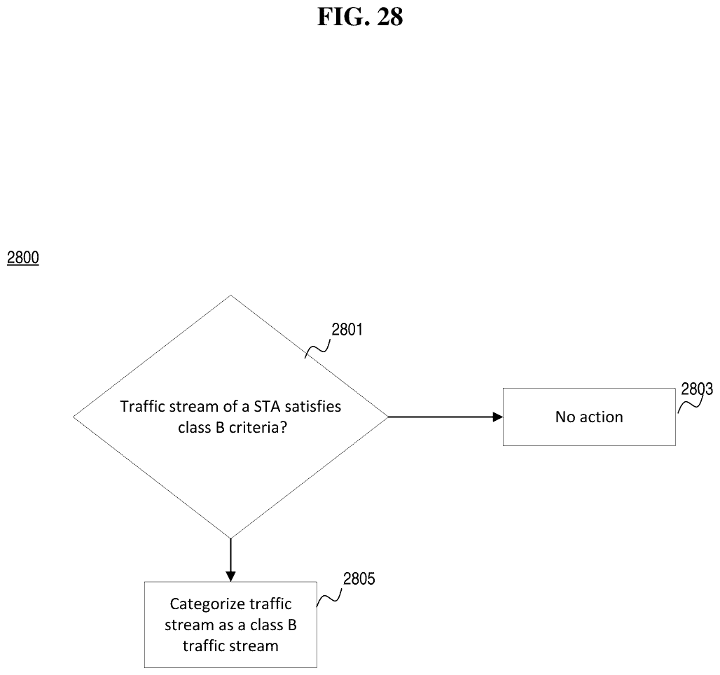

FIG. 28 illustrates a flow chart of an example process for Class B authorization policy in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 28 illustrates operations performed in a AP, such as the AP illustrated in FIG. 3.

The process 2800, in operation 2801, the AP determines whether a traffic stream of a STA satisfies a class B criteria. If the AP determines that a traffic stream of a STA does not satisfy a class B criteria, the process proceeds to operation 2803 and performs no action. If the AP determines that a traffic stream of a STA satisfies a Class B criteria, the process proceeds to operation 2805.

In operation 2805, the AP categorizes the traffic stream as a class B traffic stream. In some embodiments, when an AP has a class B traffic stream setup by the STA, the AP can authorize the STA to participate in a technique that allows for faster channel access (e.g., priority channel access mechanism).

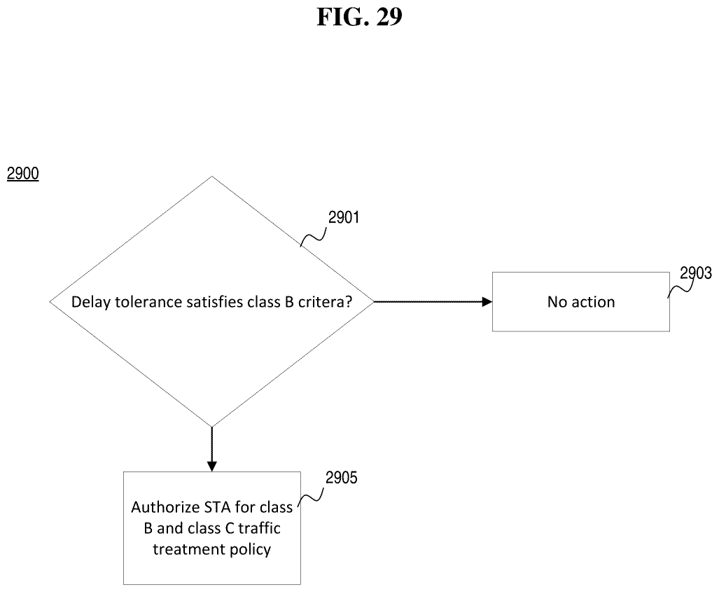

FIG. 29 illustrates a flow chart of an example process for Class B traffic treatment policy in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 29 illustrates operations performed in a AP, such as the AP illustrated in FIG. 3.

The process 2900, in operation 2901, the AP determines whether a delay tolerance of an STA satisfies a class B criteria. If the AP determines that a delay tolerance of a STA does not satisfy a class B criteria, the process proceeds to operation 2903 and performs no action. If the AP determines that a delay tolerance of a STA satisfies a class B criteria, the process proceeds to operation 2905.

In operation 2905, the AP authorizes the STA for class B and C traffic treatment policies.

Class C handling in accordance with this disclosure is described herein. In some embodiments, when an AP has class C traffic stream setup by the STA, the AP may not authorize the STA for Class A and/or Class B traffic stream treatment procedures. The STA's traffic stream may be handled by using legacy mechanisms for traffic handling.

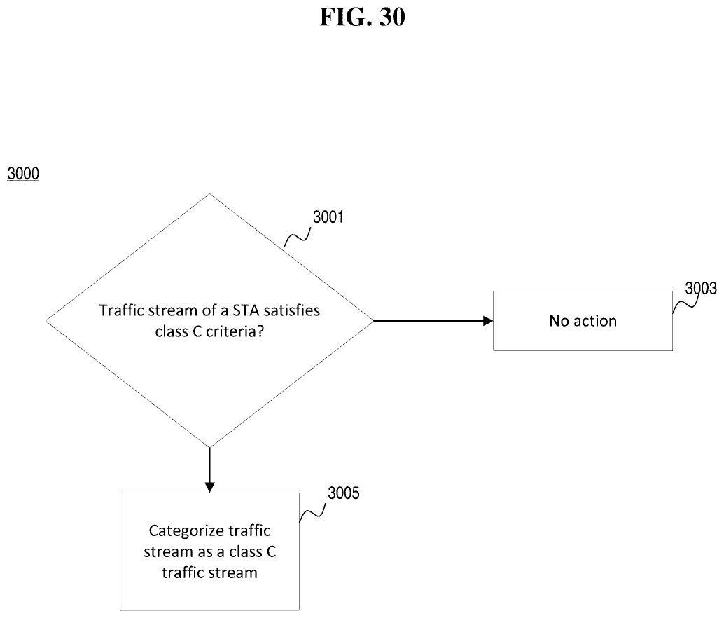

FIG. 30 illustrates a flow chart of an example process for a Class C authorization policy in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 30 illustrates operations performed in a AP, such as the AP illustrated in FIG. 3.

The process 3000, in operation 3001, the AP determines whether a traffic stream of a STA satisfies a class C criteria. If the AP determines that a traffic stream of a STA does not satisfy a class C criteria, the process proceeds to operation 3003 and performs no action. If the AP determines that a traffic stream of a STA satisfies a Class C criteria, the process proceeds to operation 3005.

In operation 3005, the AP categorizes the traffic stream as a class C traffic stream

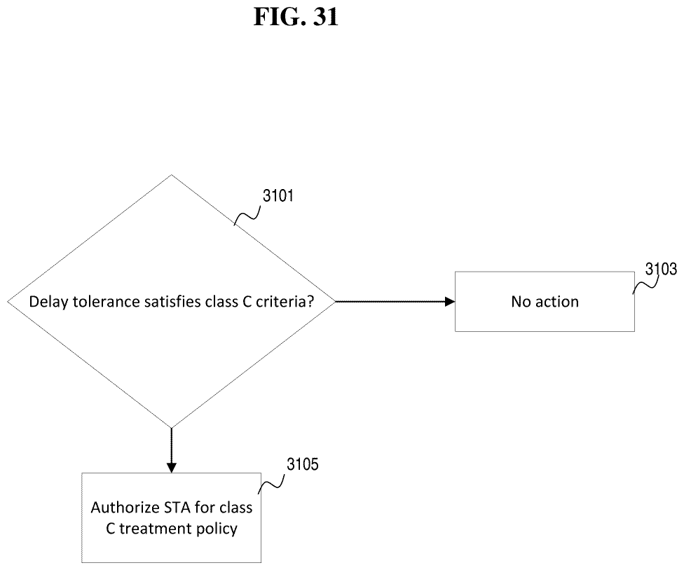

FIG. 31 illustrates a flow chart of an example process for a Class C traffic treatment policy in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 31 illustrates operations performed in a AP, such as the AP illustrated in FIG. 3.

The process 3100, in operation 3101, the AP determines whether a delay tolerance of an STA satisfies a class C criteria. If the AP determines that a delay tolerance of a STA does not satisfy a class C criteria, the process proceeds to operation 3103 and performs no action. If the AP determines that a delay tolerance of a STA satisfies a class C criteria, the process proceeds to operation 3105.

In operation 3105, the AP authorizes the STA for class C traffic treatment policies.

In some embodiments, STAs can be provided priority access based on their QoS requirements.

In some embodiments, when a STA provides its QoS information to the AP, the AP can assess if it can meet the QoS requirements of the STA (e.g., delay tolerance). If the AP cannot meet the QoS requirements of the STA, the AP can provide priority access to the STA.

In some embodiments, if the STA's delay tolerance is lower than the channel access delay, the AP can provide the STA with priority access.

In some embodiments, if the STA's traffic belongs to a particular stream (e.g., as determined by the SCS setup), the AP can provide priority access to the STA.

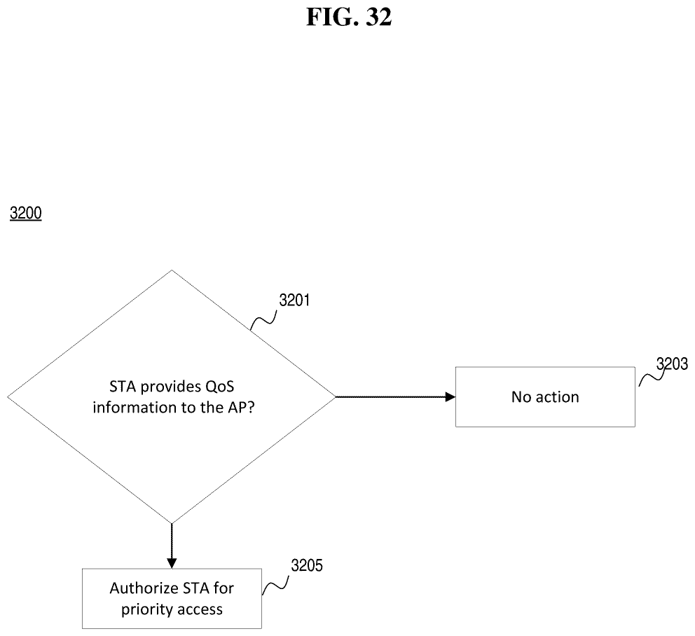

FIG. 32 illustrates a flow chart of an example process by an STA for priority access authorization for STA in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 32 illustrates operations performed in a STA, such as the STA illustrated in FIG. 3.

The process 3200, in operation 3201, the STA determines whether the STA provides QoS information to an AP. If the STA determines that it does not provide QoS information to the AP, the process proceeds to operation 3203 and performs no action. If the STA determines that it does provide QoS information to the AP, the process proceeds to operation 3205.

In operation 3205, the STA receives authorization from the AP for priority access. The STA may use a prioritized EDCA parameter set to contend for the channel.

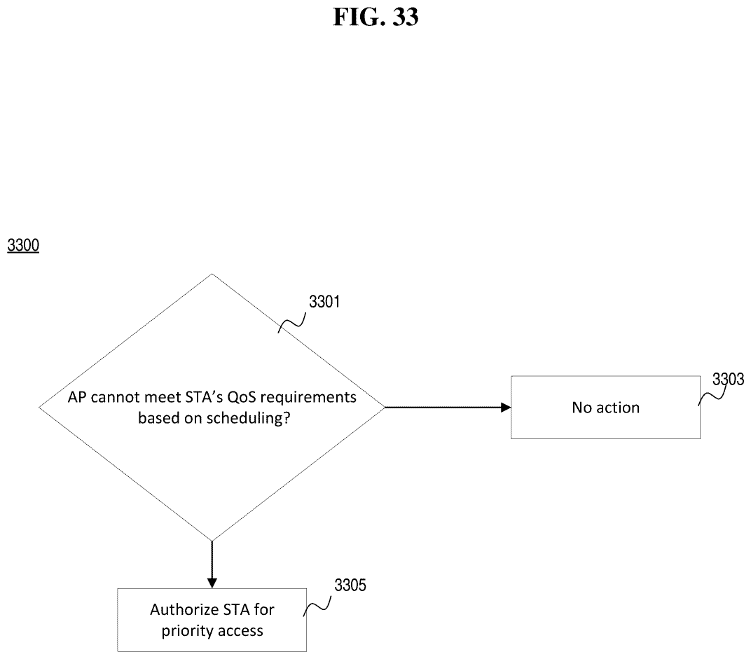

FIG. 33 illustrates a flow chart of an example process by an AP for priority access authorization for an STA in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 33 illustrates operations performed in a AP, such as the AP illustrated in FIG. 3.

The process 3300, in operation 3301, the AP determines whether it cannot meet an STA's Qos requirements based on scheduling. If the AP determines that it can meet an STA's QOS requirements based on scheduling, then the process proceeds to operation 3303 and performs no action. If the AP determines that it cannot meet an STA's QOS requirements based on scheduling, then the process proceeds to operation 3305.

In operation 3305, the AP authorizes the STA for priority access. Accordingly, the STA may use a prioritized EDCA parameter set to contend for the channel.

In some embodiments, the priority access can be provided upon request. In some embodiments, the STA can transmit a priority access enable request message to the AP. The priority access enable request message can include at least one or more of the information items as indicated in Table 5.

Table 5 illustrates contents of a priority access enable request message in accordance with an embodiment.

TABLE 5

| Information | |
|---|---|
| item | Description |
| Traffic | One or more information item(s) that can describe the type |
| identifier | of traffic for which priority access can be requested. e.g., |
| | access category (AC), traffic identifier (TID), SCS ID, |
| | among others. |
| Requested | One or more information item(s) that can describe the time |
| start time | at which the STA can want the priority access to start. e.g., |
| | number of target beacon transmit times (TBTTs) from the |
| | current TBTT, duration in terms of time unit (TU), among |
| | others. |
| Request | One or more information item(s) that can describe the |
| duration | duration for which the STA can request priority access for. |
| | e.g., number of TBTTs from the current TBTT, among |
| | others. |
| Reason | One or more information item(s) that pcan describe the |
| information | reason for priority access request. e.g., a reason code. |
| Priority | One or more information item(s) or one or more implicit |
| access | method(s) to indicate that the STA is requesting for priority |
| request | access from the AP. e.g., a bit/flag which can take specific |
| indication | values to make the indication and other values to indicate |
| | otherwise. In one example, the act of sending a priority |
| | access enable request message can be viewed as an implicit |
| | indication. |

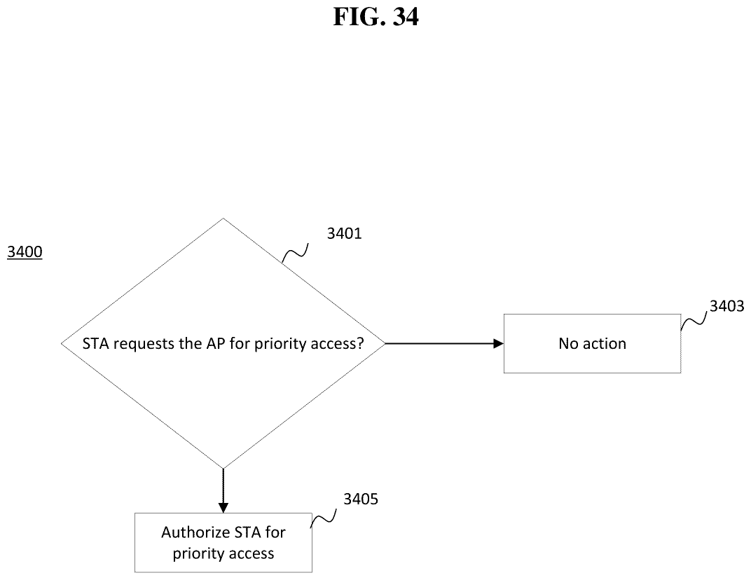

FIG. 34 illustrates a flow chart of an example process by a STA of a request based priority access authorization in accordance with an embodiment. Although one or more operations are described or shown in particular sequential order, in other embodiments the operations may be rearranged in a different order, which may include performance of multiple operations in at least partially overlapping time periods. The flowchart depicted in FIG. 34 illustrates operations performed in a STA, such as the STA illustrated in FIG. 3.

The process 3400, in operation 3401, the STA determines whether the STA requests the AP for priority access. In some embodiments, the STA may request the AP for priority access when the STA has LL traffic with frames that would otherwise expire if the STA uses normal parameters to contend for the channel. If the STA determines that the STA does not request the AP for priority access, then the process proceeds to operation 3403 and the STA performs no action. If the STA determines that the STA does request the AP for priority access, then the process proceeds to operation 3405.

In operation 3405, the STA receives authorization from the AP for priority access. The STA may use a prioritized EDCA parameters set (AIFSN, CWmin, CWmax, TXOP) to contend for the channel.

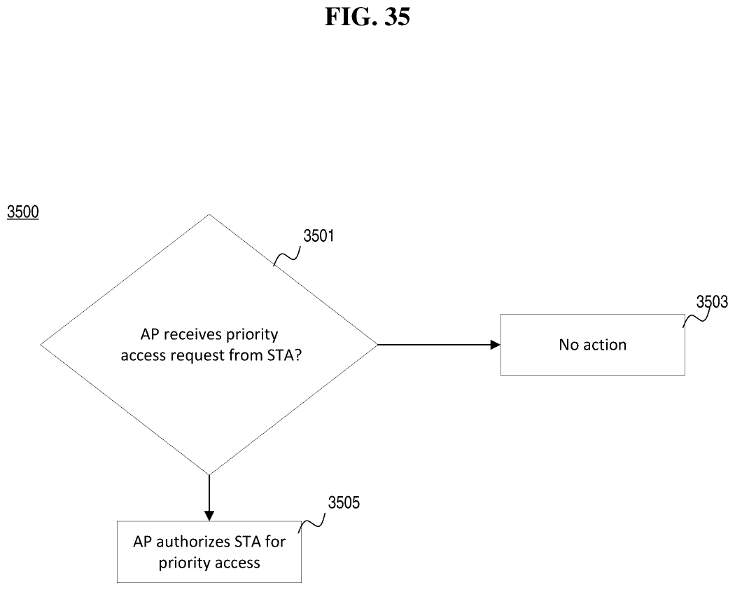

FIG. 35 illustrates a flow chart of an example process by an AP for authorization of an STA for priority access in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 35 illustrates operations performed in a AP, such as the AP illustrated in FIG. 3.

The process 3500, in operation 3501, the AP determines whether the AP receives a request from an STA for priority access. If the AP determines that the AP does not receive a request from an STA for priority access, the process proceeds to operation 3503 and performs no action. If the AP determines that the AP receives a request from an STA for priority access, the process proceeds to operation 3505.

In operation 3505, the AP authorizes the STA for priority access. In some embodiments, the AP may authorize the STA based on the STA having LL traffic among other factors.

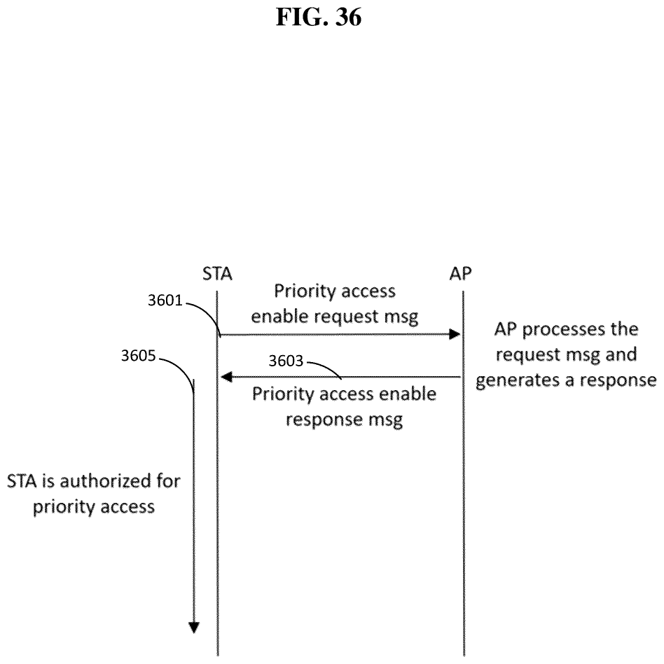

FIG. 36 illustrates an example of a request and response procedure in accordance with an embodiment. In particular, FIG. 36 illustrates communication between an AP and a STA. The STA transmits to the AP a priority access enable request message 3601. The AP processes the request message and generates a response. The AP transmits to the STA a priority access enable response message 3603. The STA is then authorized for priority access.

In some embodiments, upon receiving a priority access enable request message, the AP can process the priority access enable request message and transmit a priority access enable response message to the STA. The priority access enable response message can include at least one or more of the information items as indicated in Table 6.

Table 6 illustrates information items that may be present in a priority access enable response message in accordance with an embodiment.

TABLE 6

| Information | |
|---|---|
| item | Description |
| Traffic | One or more information item(s) that can describe the type |
| identifier | of traffic for which priority access can be provided. e.g., |
| | access category (AC), TID, SCS ID, among others. |
| Requested | One or more information item(s) that can describe the time |
| start time | at which the AP can allow the priority access to start. e.g., |
| | number of TBTTs from the current TBTT, duration in terms |
| | of TU, among others. |
| Request | One or more information item(s) that can describe the |
| duration | duration for which the AP can allow priority access for the |
| | STA. e.g., number of TBTTs from the current TBTT, |
| | among others. |
| Status | One or more information item(s) that can describe the status |
| information | for the priority access request. e.g., a status code. |
| Enhanced | One or more information item(s) that can describe the |
| operation | operation parameters that can be used for priority access. |
| parameters | e.g., a prioritized EDCA/MU EDCA parameter set. |

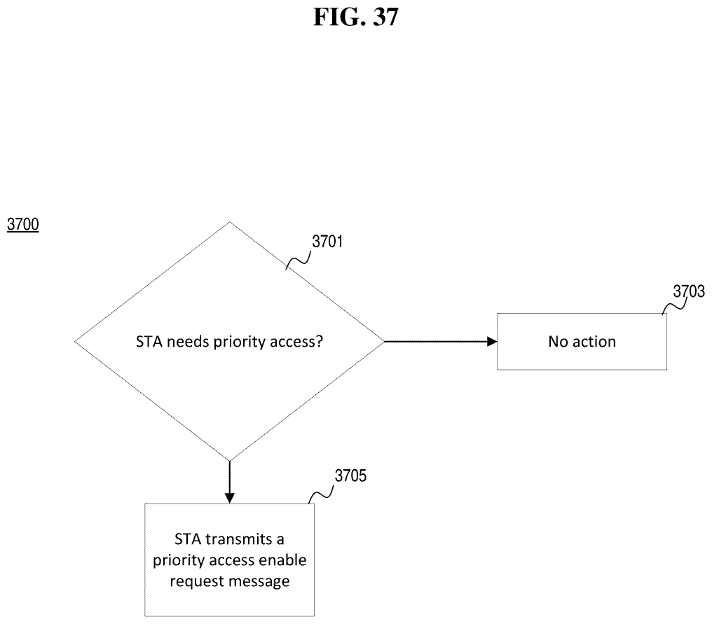

FIG. 37 illustrates a flow chart of an example process by a STA for priority access enable request handling in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 37 illustrates operations performed in a STA, such as the STA illustrated in FIG. 3.

The process 3700, in operation 3701, the STA determines whether the STA needs priority access. In some embodiments, the STA may needs priority access to handle LL frames. If the STA determines that the STA does not need priority access, the process proceeds to operation 3703 and the STA performs no action. If the STA determines that the STA needs priority access, the process proceeds to operation 3705.

In operation 3705, the STA transmits to the AP a priority access enable request message. In some embodiments, the priority access enable request message may include one or more information item(s) that can describe the type of traffic for which priority access can be requested. e.g., access category (AC), traffic identifier (TID), SCS ID, among others. In some embodiments, the request message may include one or more information item(s) that can describe the time at which the STA can want the priority access to start. e.g., number of target beacon transmit times (TBTTs) from the current TBTT, duration in terms of time unit (TU), among others. In some embodiments, the request message may include one or more information item(s) that can describe the duration for which the STA can request priority access for. e.g., number of TBTTs from the current TBTT, among others. In some embodiments, the request message may include one or more information item(s) that can describe the reason for priority access request. e.g., a reason code. In some embodiments, the request message may include one or more information item(s) or one or more implicit method(s) to indicate that the STA is requesting for priority access from the AP. e.g., a bit/flag which can take specific values to make the indication and other values to indicate otherwise.

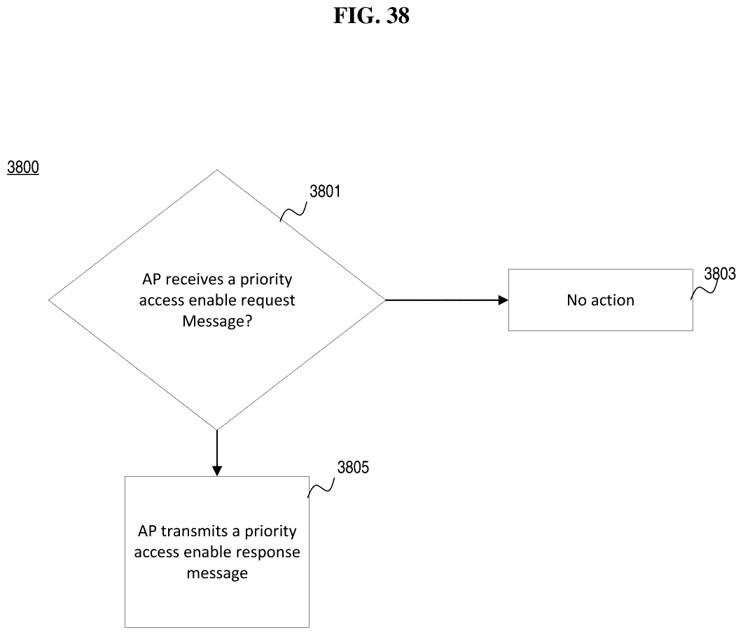

FIG. 38 illustrates a flow chart of an example process by an AP for priority access enable response frame handling in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 38 illustrates operations performed in a AP, such as the AP illustrated in FIG. 3.

The process 3800, in operation 3801, the AP determines whether the AP receives from a STA a priority access enable request message. If the AP determines that the AP does not receive a priority access enable request message, the process proceeds to operation 3803 and performs no action. If the AP the AP determines that the AP receives a priority access enable request message, the process proceeds to operation 3805.

In operation 3805, the AP transmits to the STA a priority access enable response message to the STA. In some embodiments, the response message may include one or more information item(s) that can describe the type of traffic for which priority access can be provided. e.g., access category (AC), TID, SCS ID, among others. In some embodiments, the response message may include one or more information item(s) that can describe the time at which the AP can allow the priority access to start. e.g., number of TBTTs from the current TBTT, duration in terms of TU, among others. In some embodiments, the response message may include one or more information item(s) that can describe the duration for which the AP can allow priority access for the STA. e.g., number of TBTTs from the current TBTT, among others. In some embodiments, the response message may include one or more information item(s) that can describe the status for the priority access request. e.g., a status code. In some embodiments, the response message may include one or more information item(s) that can describe the operation parameters that can be used for priority access. e.g., a prioritized EDCA/MU EDCA parameter set.

In some embodiments, priority access can be provided in an unsolicited manner. In some embodiments, the AP can transmit an unsolicited priority access enable message to the STA.

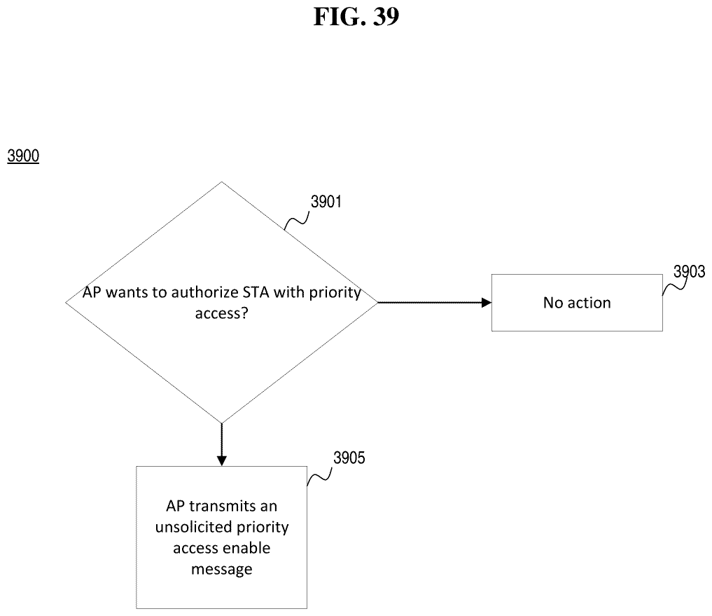

FIG. 39 illustrates a flow chart of an example process by an AP for unsolicited priority access enable procedure in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 35 illustrates operations performed in a AP, such as the AP illustrated in FIG. 3.

The process 3900, in operation 3901, the AP determines whether the AP wants to authorize a STA with priority access. If the AP determines that the AP does not want to authorize a STA with priority access, the process proceeds to operation 3903 and performs no action. If the AP determines that the AP wants to authorize a STA with priority access, the process proceeds to operation 3905.

In operation 3905, the AP transmits to the STA an unsolicited priority access enable message. The priority access enable message may include one or more of the information items provided in Table 6.

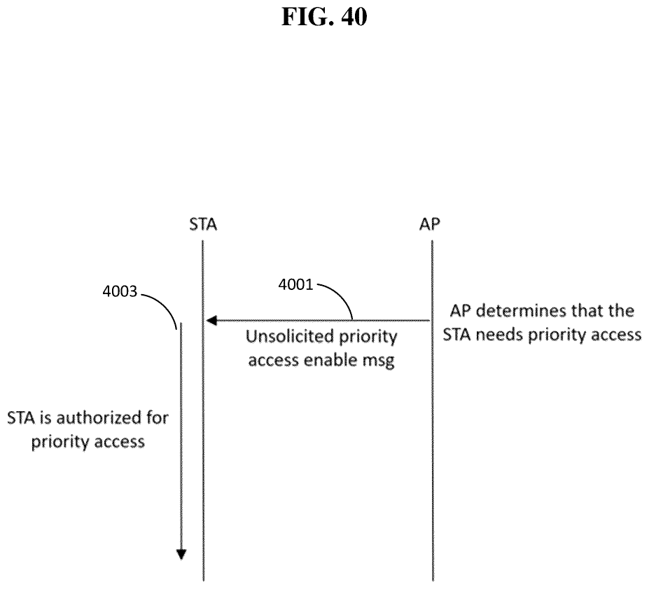

FIG. 40 illustrates an example unsolicited priority access enable procedure in accordance with an embodiment. In particular, FIG. 40 illustrates communication between an AP and a STA. The AP determines that the STA needs priority access (e.g., to meet QOS requirements, LL traffic requirements, among others). Accordingly, the AP transmits to the STA an unsolicited priority access enable message 4001, upon which, the STA is authorized for priority access 4003. In some embodiments, the priority access enable message may include one or more of the information items provided in Table 6.

In some embodiments, the STA can provide an indication of priority access when it needs. An indication may be provided either as a separate indication message (e.g., when the STA has backlog that has been delayed for a long time) or a message that is embedded in an ongoing transmission (e.g., a transmission of a different TID carrying an A-control subfield indicating priority access requirement for a different TID). Upon receiving the indication, the AP can provide priority access to the STA.

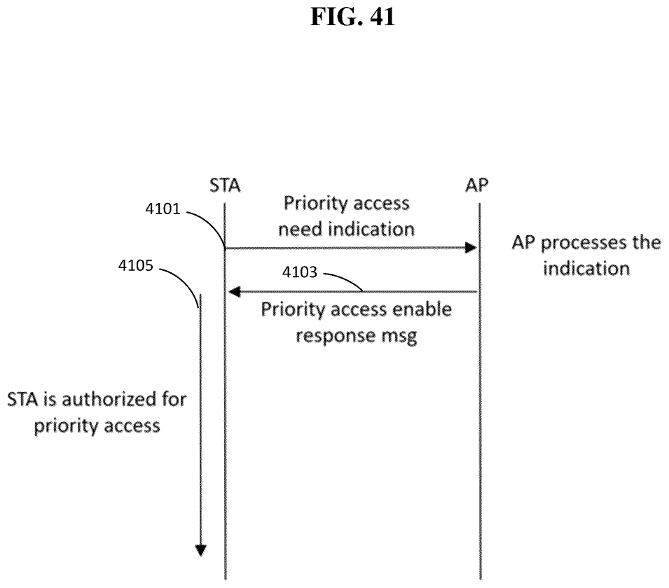

FIG. 41 illustrates an example of need based indication in accordance with an embodiment. In particular, FIG. 41 illustrates communication between an AP and a STA. The STA transmits to the AP a message 4101 that indicate a need for priority access. The AP processes the message regarding the need for priority access. The AP transmits to the STA a response message 4103 that enables priority access. In some embodiments, the response message may be priority access enable message that may include one or more of the information items provided in Table 6. Accordingly, the STA is now authorized for priority access 4105.

In some embodiments, when a STA provides QoS requirements to the AP (e.g., via SCS setup), the AP can determine if the STA needs priority access and provide priority access to it.

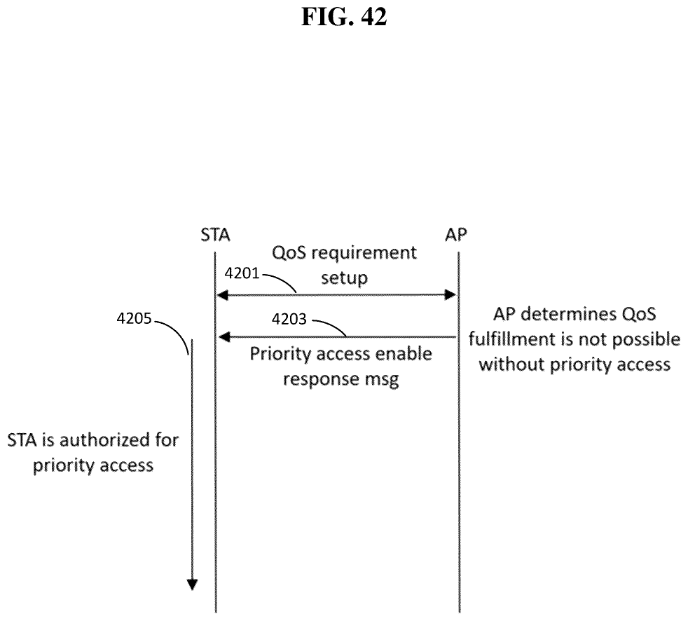

FIG. 42 illustrates an example process for QoS based indication in accordance with an embodiment. In particular, FIG. 42 illustrate communication between an AP and a STA. The STA and AP negotiate 4201 (e.g., by transmitting request and response message) a QoS requirement setup. The AP determines QoS fulfillment is not possible without priority access. The AP transits to the STA a response message 4203 that enables priority access. In some embodiments, the response message may be priority access enable message that may include one or more of the information items provided in Table 6. Accordingly, the STA becomes authorized for priority access 4205.

In some embodiments, if a STA cannot meet its uplink traffic latency requirement, the STA can transmit a request for priority access.

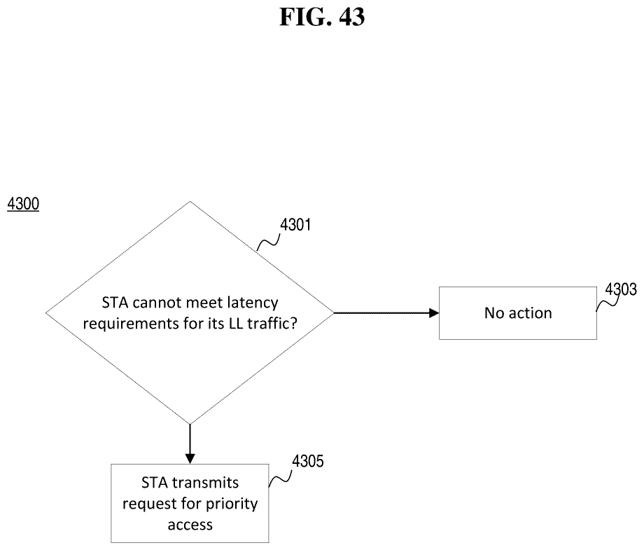

FIG. 43 illustrates a flow chart of an example process by an STA for priority access authorization in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 43 illustrates operations performed in a STA, such as the STA illustrated in FIG. 3.

The process 4300, in operation 4301, the STA determines whether it cannot meet latency requirements for its LL traffic. If the STA determines that it can meet latency requirements for its LL traffic, the process proceeds to operation 4303 and the STA performs no action. If the STA determines that it cannot meet latency requirements for its LL traffic, the process proceeds to operation 4305.

In operation 4305, the STA transmits to the AP a request for priority access. In some embodiments, the priority access enable request message may include one or more information item(s) in table 5.

In some embodiments, if a STA cannot meet its latency requirement for its LL traffic, then the AP can authorize the STA for priority access.

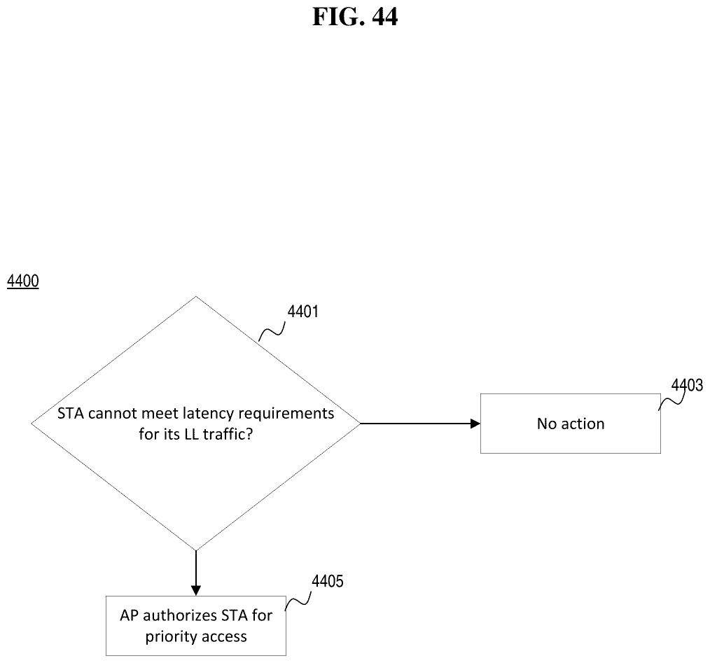

FIG. 44 illustrates a flow chart of an example process by an AP for low latency authorization in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 44 illustrates operations performed in a AP, such as the AP illustrated in FIG. 3.

The process 4400, in operation 4401, the AP determines whether the STA cannot meet latency requirements for the STA's LL traffic. If the AP determines that the STA can meet latency requirements for the STA's LL traffic, the process proceeds to operation 4403 and performs no action. If the AP determines that the STA cannot meet latency requirements for the STA's LL traffic, the process proceeds to operation 4405.

In operation 4405, the AP authorizes the STA for priority access. In some embodiments, the AP may transmit a frame that includes one or more of the information items in Table 6.

In some embodiments, when a STA provide a buffer status report (BSR) with timing information to the AP, if the AP may determine that the STA needs priority access, the AP can authorize the STA for priority access.

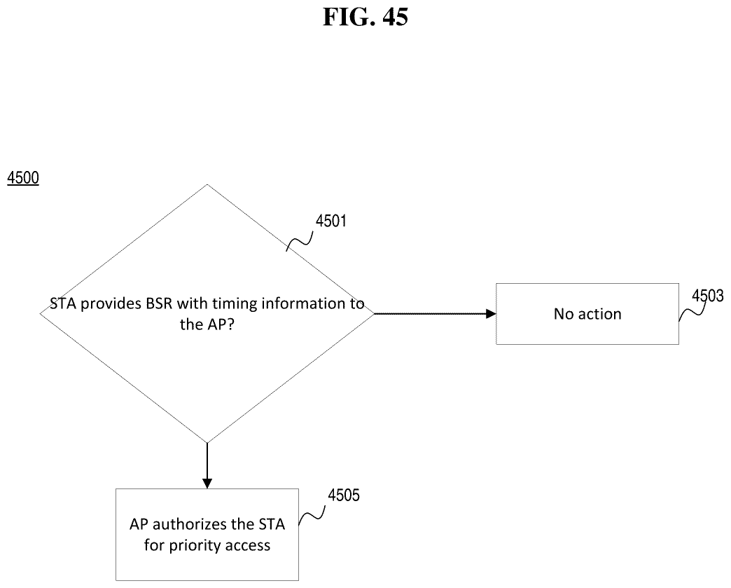

FIG. 45 illustrates enhanced BSR based authorization in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 45 illustrates operations performed in a AP, such as the AP illustrated in FIG. 3.

The process 4500, in operation 4501, the AP determines whether the STA provides BSR with timing information to the AP. In some embodiments, the BSR may provide packet expiration times of frames within a transmission buffer. If the AP determines that the STA does not provide BSR with timing information to the AP, the process proceeds to operation 4503 and performs no action. If the AP determines that the STA provides BSR with timing information to the AP, the process proceeds to operation 4505.

In operation 4505, the AP authorizes the STA for priority access. In some embodiments, the AP may determine to authorize the STA for priority access based on the timing information included in the BSR, in particular, a determination that packets are likely to expire unless the STA is granted prioritized access. In some embodiments, the AP may transmit a frame that includes one or more of the information items in Table 6.

In some embodiments, upon being authorized for priority access, the STA can update the EDCA and/or multi-user (MU) EDCA parameters provided by the AP in its response message as soon as feasible in implementation. The STA can then use the EDCA and/or MU-EDCA parameter set for its uplink transmission.

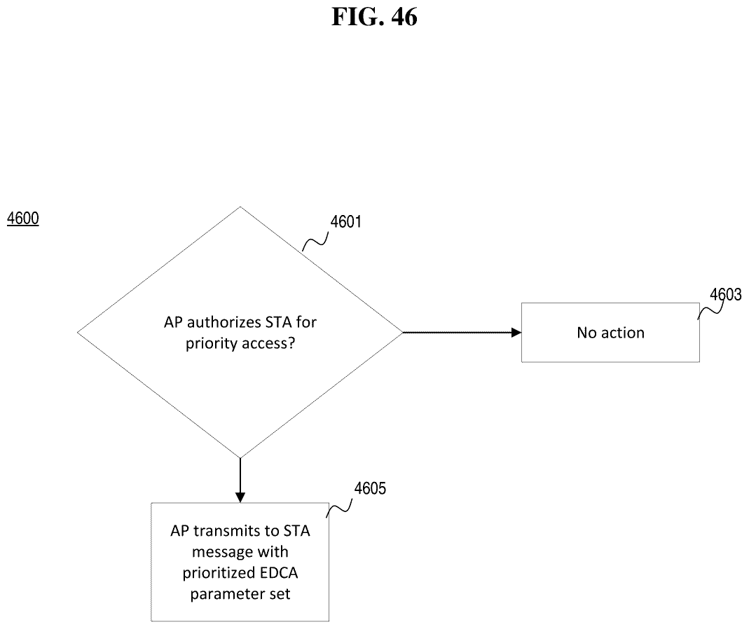

FIG. 46 illustrates a flow chart of an example process by an AP for EDCA parameter handling in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 46 illustrates operations performed in a AP, such as the AP illustrated in FIG. 3.

The process 4600, in operation 4601, the AP determines whether the AP has authorized the STA for priority access. If the AP determines that the AP has not authorized the STA for priority access, the process proceeds to operation 4603 and performs no action. If the AP determines that the AP has authorized the STA for priority access, the process proceeds to operation 4605.

In operation 4605, the AP provides STA with a prioritized EDCA parameter set. In some embodiments, the AP may transmit a frame that includes one or more of the information items in Table 6.

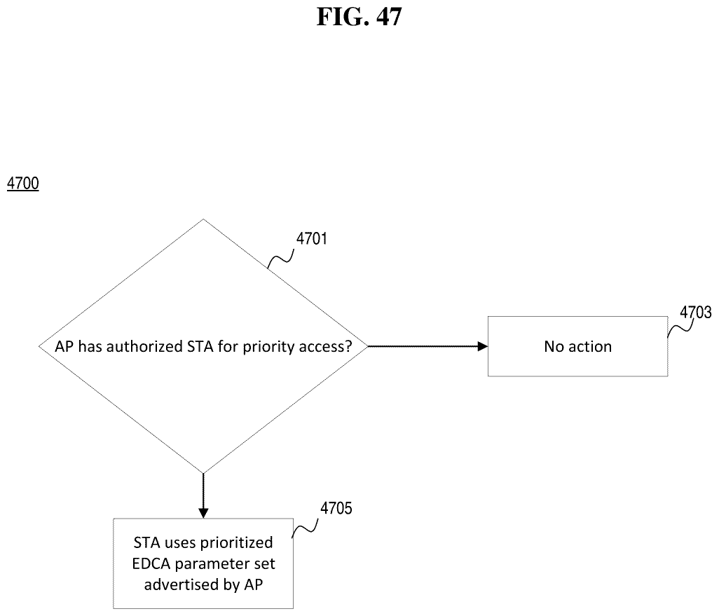

FIG. 47 illustrates a flow chart of an example process by a STA for EDCA parameter handling in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 47 illustrates operations performed in a STA, such as the STA illustrated in FIG. 3.

The process 4700, in operation 4701, the STA determines whether the AP has authorized the STA for priority access. If the STA determines that the AP has not authorized the STA for priority access, the process proceeds to operation 4703 and performs no action. If the STA determines that the AP has authorized the STA for priority access, the process proceeds to operation 4705.

In operation 4705, the STA uses a prioritized EDCA parameter set advertised by the AP. In some embodiments, the STA may used enhanced values for one or more parameters including CWmin, CWmax, AIFSN, and TXOP among others.

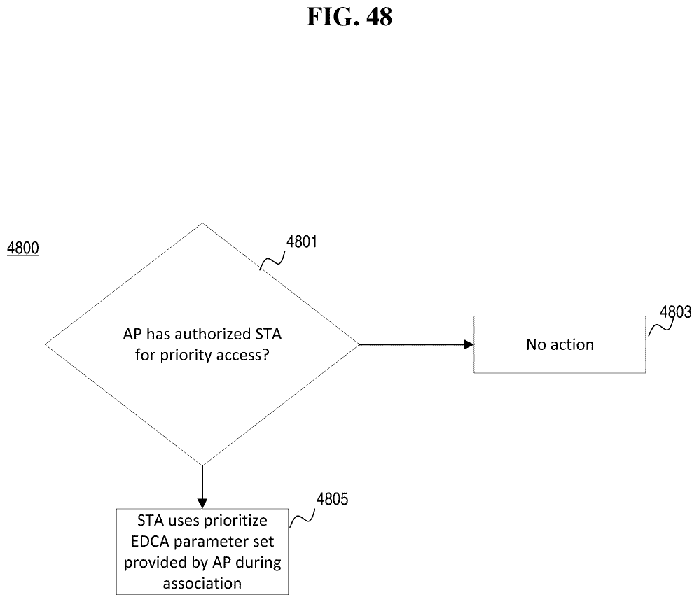

FIG. 48 illustrates a flow chart of an example process by a STA for EDCA parameter handling in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 48 illustrates operations performed in a STA, such as the AP illustrated in FIG. 3.

The process 4800, in operation 4801, the STA determines whether the AP has authorized the STA for priority access. If the STA determines that the AP has not authorized the STA for priority access, the process proceeds to operation 4803 where the STA performs no action. If the STA determines that the AP has authorized the STA for priority access, the process proceeds to operation 4805.

In operation 4805, the STA uses the prioritized EDCA parameter set provided by the AP during association. In some embodiments, when a STA associates with an AP, the AP can provide the STA with multiple EDCA parameter sets. When the STA is authorized for priority access, the AP can provide the STA with an indication of which priority access parameters to use. The STA can then switch to those priority access parameters.

In some embodiments, if the AP is a MLD and the non-AP is an MLD, then the AP can authorize both the STAs affiliated with the non-AP MLD in one response message. The AP can provide the EDCA and/or MU EDCA parameters for both the links (tagged with a link indication such as a link ID) in one priority access enable response message.

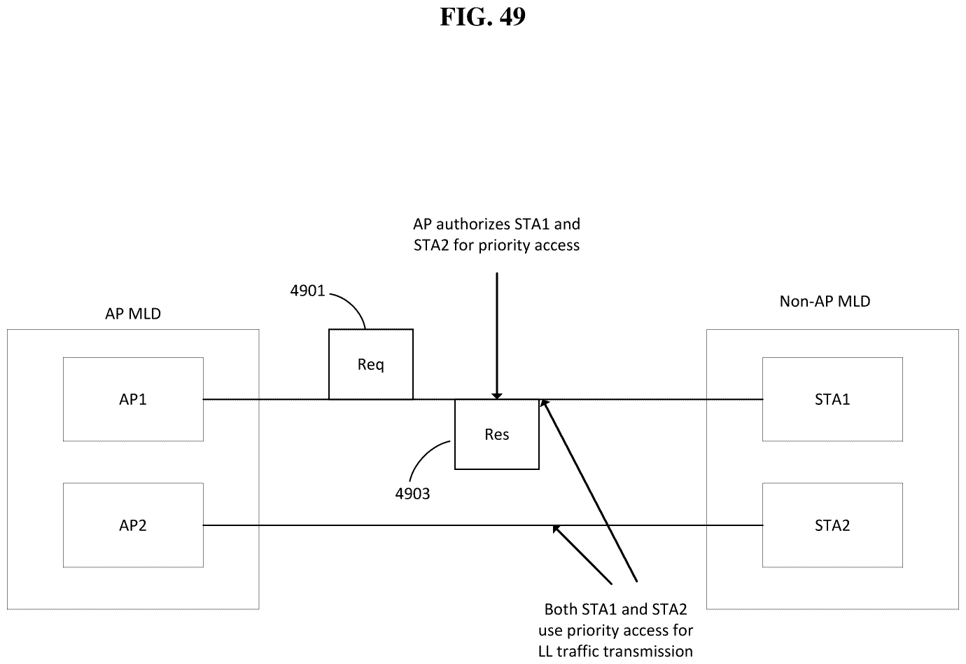

FIG. 49 illustrates a first example in accordance with an embodiment. In particular, FIG. 49 illustrates AP MLD that includes AP1 and AP2 that are affiliated with the AP MLD, and non-AP MLD that includes STA1 and STA2 that are affiliated with the non-AP MLD. STA1 is associated with AP1 and STA2 is associated with AP2. AP1 receives a request message 4901 from STA1. AP1 transmits a response message 4903 to STA1 where the response message may authorize STA1 and STA2 for priority access. Accordingly, both STA1 and STA2 may use priority access for LL traffic transmissions.

In some embodiments, an STA that operates on a link can be authorized for priority access via a negotiation that can occur on a different link. For example, a second STA, STA2, can be authorized for priority access via a negotiation that can occur on link 1 between a first AP and a first STA.

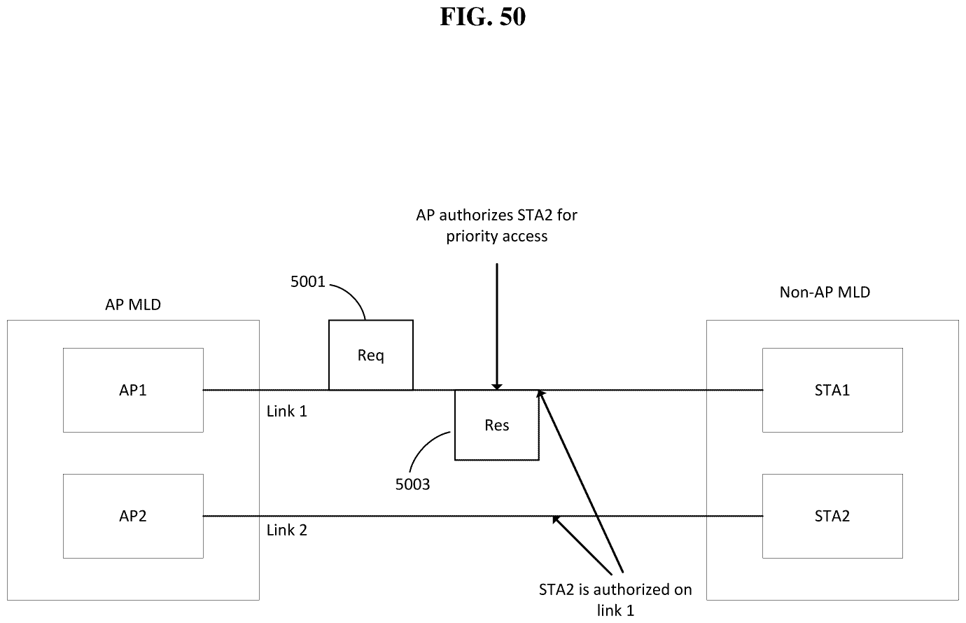

FIG. 50 illustrates an example multi-link priority access authorization in accordance with an embodiment. In particular, FIG. 50 illustrates AP MLD that includes AP1 and AP2 that are affiliated with the AP MLD, and non-AP MLD that includes STA1 and STA2 that are affiliated with the non-AP MLD. STA1 is associated with AP1 on link 1 and STA2 is associated with AP2 on link 2. AP1 receives a request frame 5001 from STA1 where the request frame includes a request for priority access authorization for STA2. AP1 transmits to STA1 a response message 5003 that authorizes priority access for STA2 on link 1.

In some embodiments, when the STA is authorized for priority access, there can be a priority access termination time beyond which the priority access can be considered invalid unless it is reset.

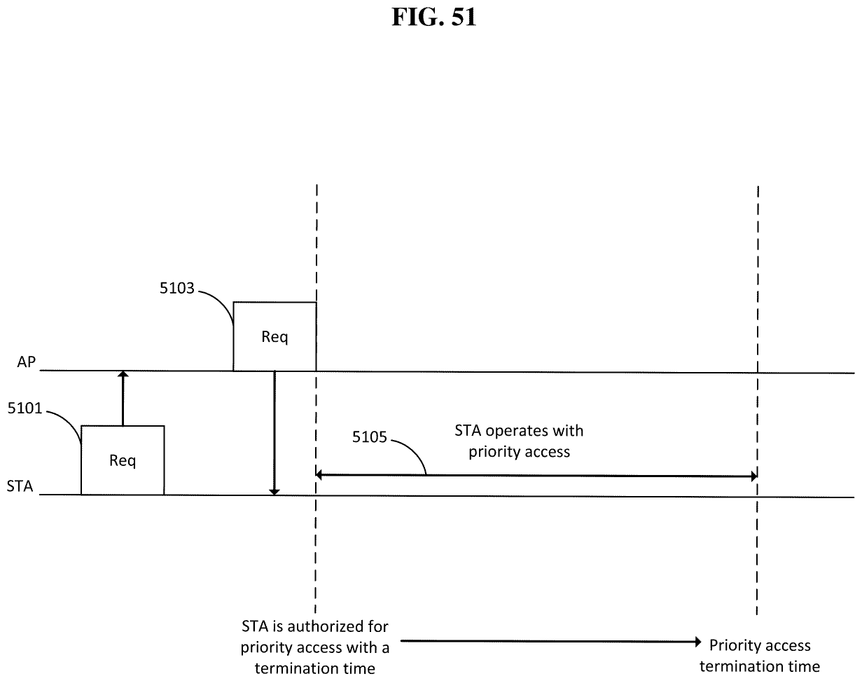

FIG. 51 illustrates an example for priority access authorization within a time duration in accordance with an embodiment. In particular, FIG. 50 illustrates communication between an AP and a STA. The STA transmits to the AP a request frame 5101, where the request frame may request from the AP authorization for priority access. The AP transmits to the STA a response frame 5103 that may authorize the STA for priority access with a termination time. Accordingly, during duration 5105, the STA may operate with priority access. After duration 5105, the priority access may terminate at the indicated priority access termination time.

In some embodiments, when the STA is authorized for priority access, it can be considered to be in priority access state unless there is an explicit teardown message from the AP.

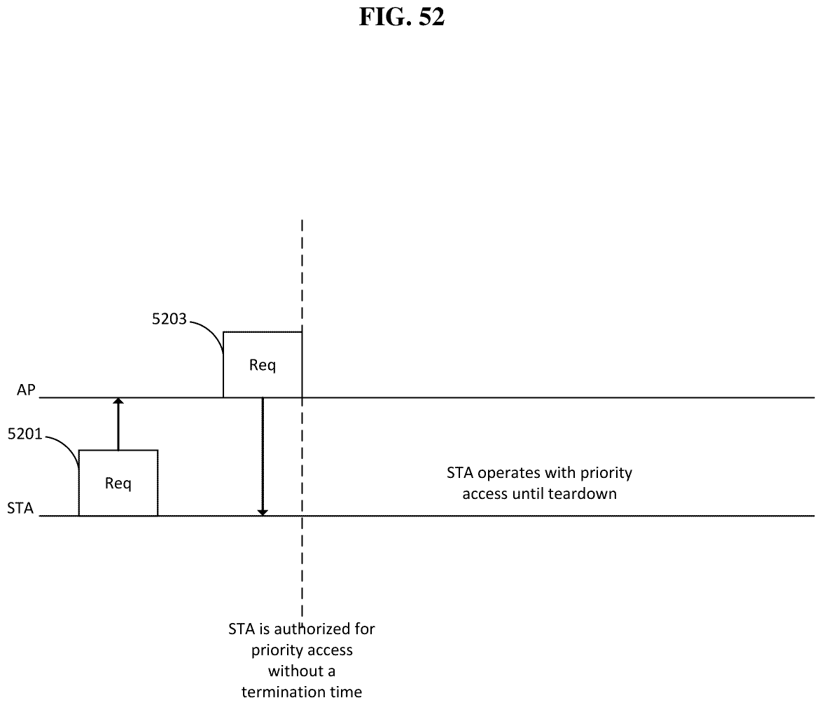

FIG. 52 illustrates an example priority access with an explicit teardown in accordance with an embodiment. In particular, FIG. 52 illustrates communication between an AP and a STA. The STA transmit to the AP a request frame 5201 which may request priority access. The AP transmits to the STA a response frame 5203 that may authorize the STA for priority access. Accordingly, the STA is authorized for ongoing priority access without termination (e.g., there is not explicit tear down message in this example).

In some embodiments, there can be a priority access enable request element.

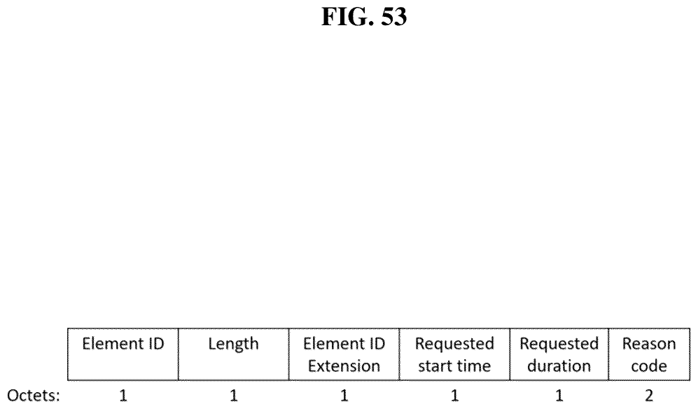

FIG. 53 illustrates a priority access enable request element in accordance with an embodiment. The element may include an element ID field, a length field, a element ID extension field, a requested start time field, a requested duration field, and a reason code. The element ID field may provide an identifier of the element. The length field may provide length information of the element. The element ID extension field may provide ID extension information. The requested start time field may provide a requested start time for a priority access. The requested duration field may provide duration information regarding a duration of the priority access. The reason code may provide reason information regarding the reason for requesting priority access.

In some embodiments, there can be a priority access enable response element.

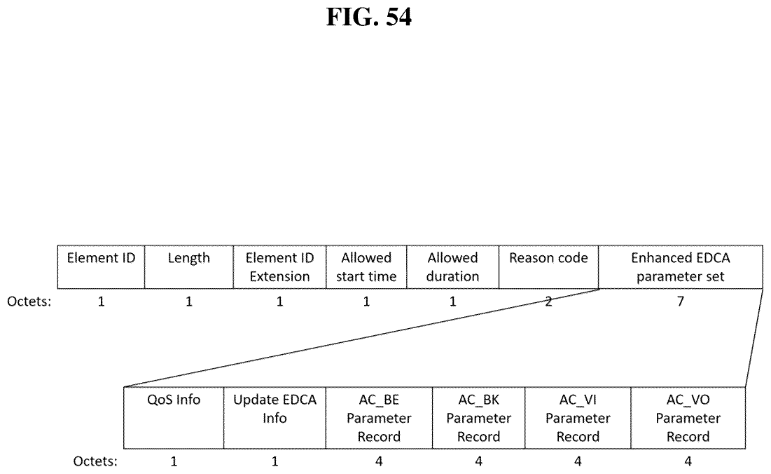

FIG. 54 illustrates a priority access enable response element in accordance with an embodiment. The element may include an element ID field, a length field, an element ID extension field, an allowed start time field, an allowed duration field, a reason code filed, a prioritized EDCA parameter set field. The prioritized EDCA parameter set field may include a QoS info field, a updated EDCA info field, a AC_BE parameter record field, a AC_BK parameter record field, a AC_VI parameter record field, and a AC_VO parameter record field.

The element ID field may provide an identifier of the element. The length field may provide length information of the element. The element ID extension field may provide ID extension information. The allowed start time field may provide an allowed start time for a priority access. The allowed duration field may provide duration information regarding a duration of the priority access. The reason code may provide reason information regarding the reason for the priority access. The prioritized EDCA parameter set may include prioritized EDCA parameter information for the priority access. The QoS Info field may provide QoS information regarding the traffic characteristics and/or requirements for the traffic associated with the STA. In some embodiments, the QoS Info field can include the EDCA Parameter Set Update Count subfield, which can be initially set to 0 and can be incremented each time any of the announced EDCA parameters change.

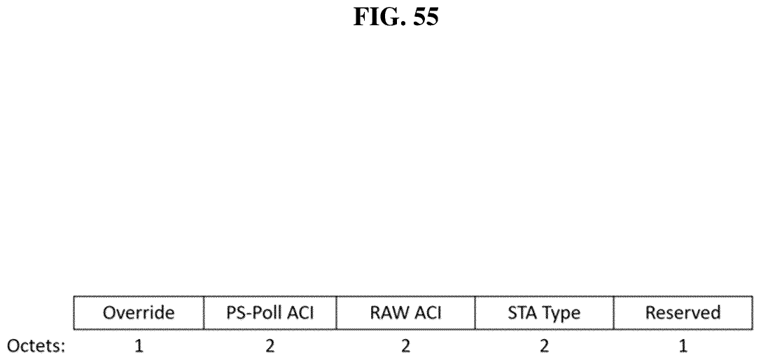

The updated EDCA info field may provide updated EDCA information to the STA. In some embodiments, the update EDCA Info field can have a format as shown in FIG. 55 in accordance with an embodiment.

The AC_BE parameter record may provide one or more parameter values for the AC_BE traffic category. Th AC_BK parameter record field may provide one or more parameter values for the AC_BK traffic category. The AC_VI parameter record field may provide one or more parameter values for the AC_VI traffic category. The AC_VO parameter record field may provide one or more parameter values for the AC_VO traffic category.

FIG. 55 illustrates an update EDCA Info field format in accordance with an embodiment. The field may include an override field, a PS-Poll ACI field, a RAW ACI field, a STA type field, and a reserved field.

The override field can be used by the AP to indicate to the STA that the element can override previously stored EDCA parameters. The PS-Poll ACI field can be used by the AP to inform the STA of the access category for sending a PS-Poll frame. The mapping between the PS-Poll ACI field and AC can be identical to the ACI to AC coding shown in Table 7 below.

Table 7 illustrates ACI to AC coding in accordance with an embodiment.

TABLE 7

| ACI | AC | Description |
|---|---|---|
| 0 | AC_BE | Best effort |
| 1 | AC_BK | Background |
| 2 | AC_VI | Video |
| 3 | AC_VO | Voice |

The STA type can indicate the type of STA for which the information in the element can be provided. For example, 0 can indicate that the information is valid for all STAs, 1 can indicate that it is valid for sensor STAs, among others. The reserved field may be reserved.

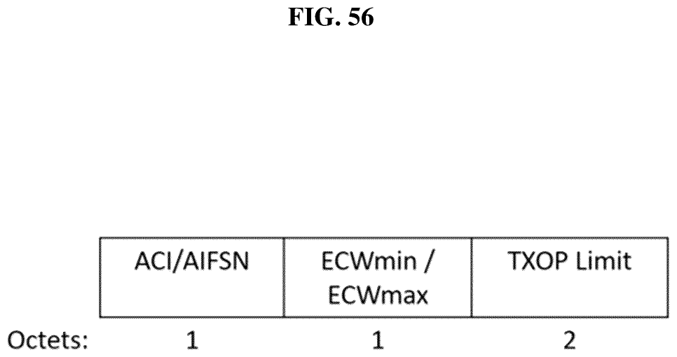

The parameter record field can have a format as shown in FIG. 56 in accordance with an embodiment.

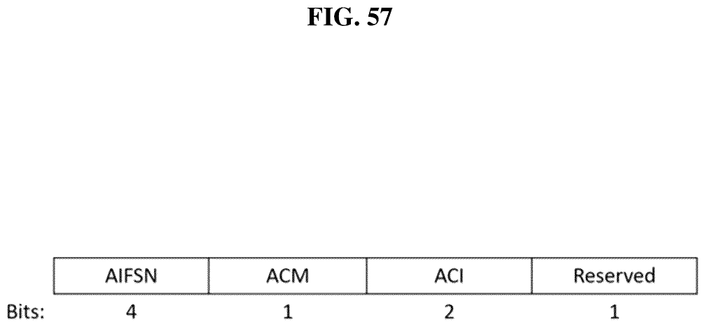

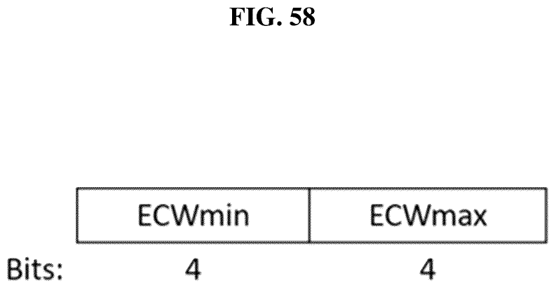

FIG. 56 illustrates a parameter record field format in accordance with an embodiment. The parameter record field may include access category index (ACI) arbitration inter-frame spacing AIFSN field (ACI/AIFSN), a minimum contention window/maximum contention window size (ECWmin/ECWmax) field, and a transmission opportunity (TXOP) limit field. The ACI/AIFSN field may provide ACI/AIFSN information and may have a format as shown in FIG. 57 in accordance with an embodiment. The ECWmin/ECWmax field may provide values for the minimum and maximum contention window size. The ECWmin/ECWmax field can have a format as shown in FIG. 58 in accordance with an embodiment. In some embodiments, the ECWmin and

ECWmax fields can encode the values of CWmin and CWmax in an exponent form. The TXOP limit field can specify the maximum TXOP value.

FIG. 57 illustrates a ACI/AIFSN field format in accordance with an embodiment. The ACI/AIFSN field format may include an AIFSN field, an admission control mandatory (ACM) field, a access category index (ACI) field, and a reserved field.

The AIFSN field can indicate the number of slots after a SIFS a STA can defer before either invoking a backoff or starting a transmission. The value of the AC index (ACI) can reference the AC to which all parameters in this record correspond. The mapping between ACI and AC may be defined in Table 7. The ACM (admission control mandatory) field can indicate that admission control is required for the AC. In some embodiments, if the ACM subfield is equal to 0, then there is no admission control for the corresponding AC. If the ACM subfield is set to 1, admission control may have to be used prior to transmission using the access parameters specified for this AC.

FIG. 58 illustrates a ECWmin/ECWmax field format in accordance with an embodiment. In some embodiments, the ECWmin and ECWmax fields can encode the values of CWmin and CWmax in an exponent form.

In some embodiments, the request can be made by including the request element in an SCS request frame.

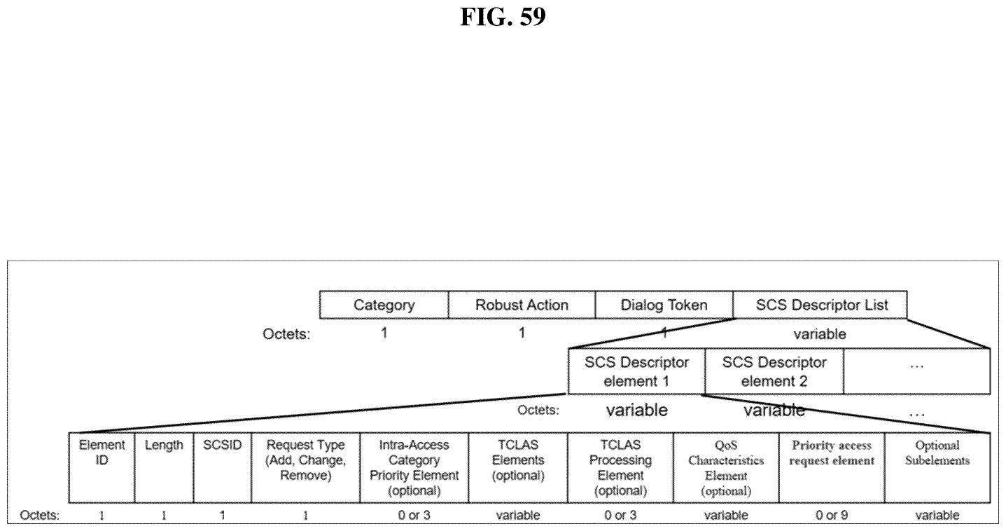

FIG. 59 illustrates an enhanced SCS request format in accordance with an embodiment. The SCS request frame may include a category field, a robust action field, a dialog token field, an SCS descriptor list.

The Category field may be set to a value that indicates a category of the SCS request frame that is an action frame. The Robust Action field may have a value associated with the SCS request frame format within predefined robust AV streaming category. The Dialog Token field may be used for matching action response with action requests when there are multiple, concurrent action requests. The SCS Descriptor List field may include one or more SCS Descriptor elements.

In particular, the SCS Descriptor element can include an Element ID field, Length field, SCSID field, Request Type field, Intra-Access Category Priority element field (optional), TCLAS elements field (optional), TCLAS processing element field (optional), QoS Characteristics element field (optional), a Priority Access Request Element field, and an Optional Subelements field.

The Element ID field may include information to identify a type of the SCS Descriptor element. The Length field may indicate a length of the SCS Descriptor element. The SCSID field may include information to identify the SCS descriptor element. The Request Type field can be set to indicate the request type (i.e., Add, Remove, and Change) of the SCS descriptor element. In some embodiments, the Request Type field may indicate that the SCS request is for another AP. In some embodiments, the Request Type field can be set to a value that indicates to the current AP that the SCS agreement is for the target AP. The current AP can then transmit the SCS request to the candidate or target AP MLD(s). In some embodiments, a presence of a roaming request indication message may act as an implicit indication.

The Intra-Access Category Priority element field may be present when the Request Type field is equal to “Add” or “Change.” The TCLAS element field may include information on a traffic classification. The TCLAS processing element field may include information on a method of processing a traffic from an upper layer. The QoS Characteristics element field may include a set of parameters that define the characteristics and QoS expectations of a traffic flow. The Priority Access Request element may include information regarding a request for priority access.

In some embodiments, a response can be provided in an SCS response frame.

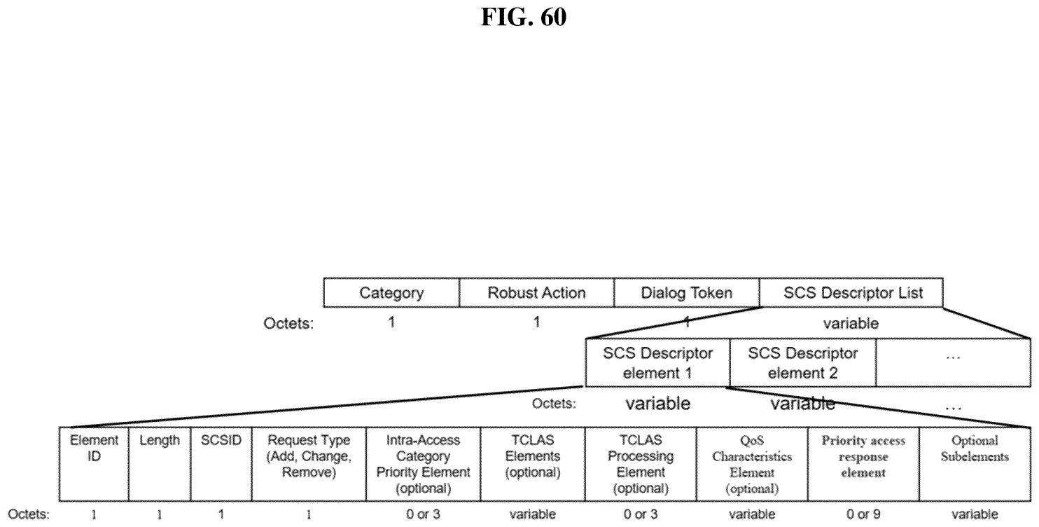

FIG. 60 illustrates an SCS response format in accordance with an embodiment. The fields in FIG. 60 may include similar fields to FIG. 59 and there description is omitted herein. In particular, in FIG. 60, the SCS descriptor element may include a Priority Access Response Element field that includes information regarding a response to a request for priority access.

In some embodiments, the request and response can be done via action frames. The action frame for request can have a format as shown in Table 8.

Table 8 illustrates a request frame action field format in accordance with an embodiment.

TABLE 8

| Order | Meaning |
|---|---|
| 1 | Category |
| 2 | Protected UHR action |
| 3 | Dialog token |
| 4 | Priority access enable request element |

The dialog token can be set to a nonzero value that is chosen by the requester when transmitting the request frame.

The priority access enable request element can have a format as shown in FIG. 53 in accordance with an embodiment.

The response action frame can have a format as shown in Table 9.

Table 9 illustrates a response frame action field format in accordance with an embodiment.

TABLE 9

| Order | Meaning |
|---|---|
| 1 | Category |
| 2 | Protected UHR |
| 3 | Dialog Token |
| 4 | Status Code |
| 5 | Priority access enable response element |

The dialog token can have the same value as in the request frame. The status code can indicate the status of the request. The priority access enable response element can have a format as shown in FIG. 54 in accordance with an embodiment. The above embodiments can also apply to other types of communication (e.g., P2P, relay, among others). In some embodiments, the requester may not be limited to a STA and can be any other type of device and the response can also be any other type of device.

Applications such as those described herein may require special treatment depending on their delay tolerance. In some cases where the application's delay tolerance is on the order of channel access delay, the application may be provided with an enhanced or prioritized EDCA parameter set for transmission of its LL traffic.

However, as the network conditions change, the EDCA parameters provided to the device can become stale. Thus, even with a prioritized EDCA parameter set, the device may not be able to get priority access to the wireless medium to transmit it's LL traffic. Embodiments in accordance with this disclosure may provide procedures by which these parameters can be updated.

In some embodiments, an STA can teardown its current LL session and update the LL session again. Thus, upon a new LL session setup, the STA can obtain an updated prioritized EDCA parameter set that is designed as per the current network and traffic conditions.

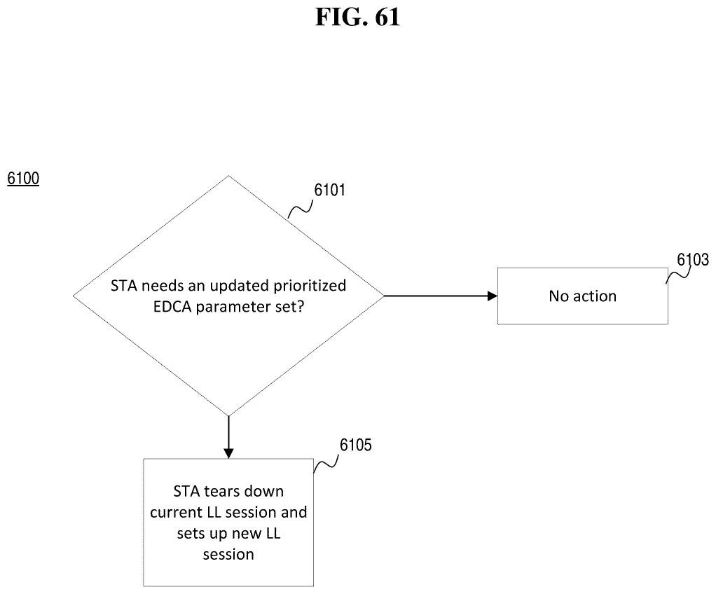

FIG. 61 illustrates a flow chart of an example process by an STA of an LL session teardown and re-setup procedure in accordance with an embodiment. Although one or more operations are described or shown in particular sequential order, in other embodiments the operations may be rearranged in a different order, which may include performance of multiple operations in at least partially overlapping time periods. The flowchart depicted in FIG. 61 illustrates operations performed in a STA, such as the STA illustrated in FIG. 3.

The process 6100, in operation 6101, the STA determines whether the STA needs an updated prioritized EDCA parameter set. In some embodiments, the STA may need an update if the STA no longer has LL traffic for a particular LL application or is no longer operating a LL application. If the STA determines that the STA does not need an updated prioritized EDCA parameter set, the process proceeds to operation 6103 and the STA performs no action. If the STA determines that the STA needs an updated prioritized EDCA parameter set, the process proceeds to operation 6105.

In operation 6105, the STA tears down its current priority access or current LL session and sets up a new priority access or new LL session whereby the STA may request and receive an updated EDCA parameter set. In some embodiments the updated EDCA parameter set may be for a different LL application and/or different LL traffic for a different stream.

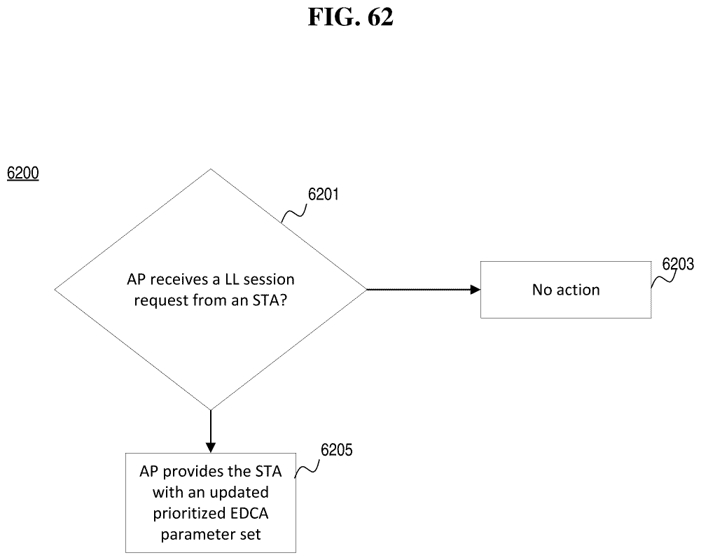

FIG. 62 illustrates a flow chart of an example process by an AP of a prioritized EDCA parameter update in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 62 illustrates operations performed in a AP, such as the AP illustrated in FIG. 3.

The process 6200, in operation 6201, the AP determines whether the AP receives a LL session request from an STA. If the AP determines that the AP does not receive a LL session request from an STA, the process proceeds to operation 6203 and performs no action. If the AP determines that the AP receives a LL session request from an STA, the process proceeds to operation 6205.

In operation 6205, the AP provides the STA with an updated prioritized EDCA parameter set. In some embodiments the updated EDCA parameter set may be for a different LL application and/or different LL traffic for a different stream.

In some embodiments, when the AP detects that the current prioritized EDCA parameter set has become stale or needs to be updated, the AP can also teardown and re-setup the LL session.

In some embodiments, an AP can stop advertising a LL session support or priority access support in its beacons for a certain number of TBTTs. This advertisement can result in an implicit teardown of an LL session at the STAs. After a sufficient number of TBTTs, the AP can again start to advertise its LL session support capability in its beacons. This can trigger the STAs to re-setup their LL sessions with the AP.

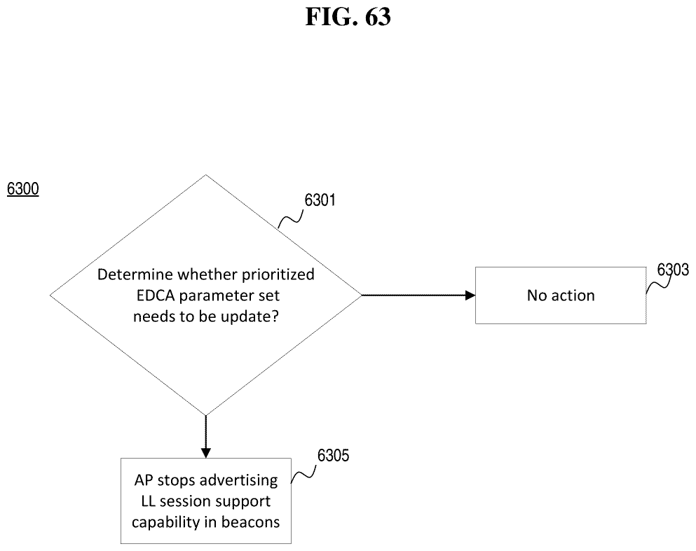

FIG. 63 illustrates a flow chart of an example process by an AP of an advertised capability-based teardown and reset up in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 63 illustrates operations performed in a AP, such as the AP illustrated in FIG. 3.

The process 6300, in operation 6301, the AP determines whether a prioritized EDCA parameter set needs to be updated. If the AP determines that a prioritized EDCA parameter set does not need to be updated, the process proceeds to operation 6303 and the AP performs no action. If the AP determines that a prioritized EDCA parameter set needs to be updated, the process proceeds to operation 6305.

In operation 6305, the AP stops advertising LL session support capability in its beacons.

In some embodiments, an unsolicited update message can be transmitted to the STA by the AP. The unsolicited update message can include at least one or more of the information items as shown in Table 10.

Table 10 illustrates an unsolicited update message content in accordance with an embodiment.

TABLE 10

| Information | |
|---|---|
| item | Description |
| Reason | One or more information item(s) that can describe the |
| information | reason for sending this message. e.g., a reason code that can |
| | specify that this is an unsolicited EDCA parameter update |
| | message. |
| LL session | One or more information item(s) that can indicate the LL |
| indicator | session whose parameters are being updated. e.g., an |
| | identifier or ID. |
| Updated | One or more information item(s) that can indicate an update |
| EDCA | prioritized EDCA parameter set. This can be for one or |
| parameter | more of the links setup between the AP and the STA. The |
| set | prioritized EDCA parameter set can be the prioritized |
| | EDCA and MU EDCA parameter set. |

Upon receiving the above frame, the STA can update its EDCA parameters and continue its operation with a prioritized EDCA parameters as soon as possible in implementation. In some embodiments, the device can update its dot11EDCATable to the values indicated in the message.

In some embodiments, a message can be transmitted in a unicast manner. In particular, for each STA, the AP can transmit one update message that has prioritized EDCA parameter set that match its requirements.

In some embodiments, a message may be transmitted in a groupcast or broadcast manner. In particular, for a group of STAs for whom the LL sessions have been setup, the AP can transmit an unsolicited update message.

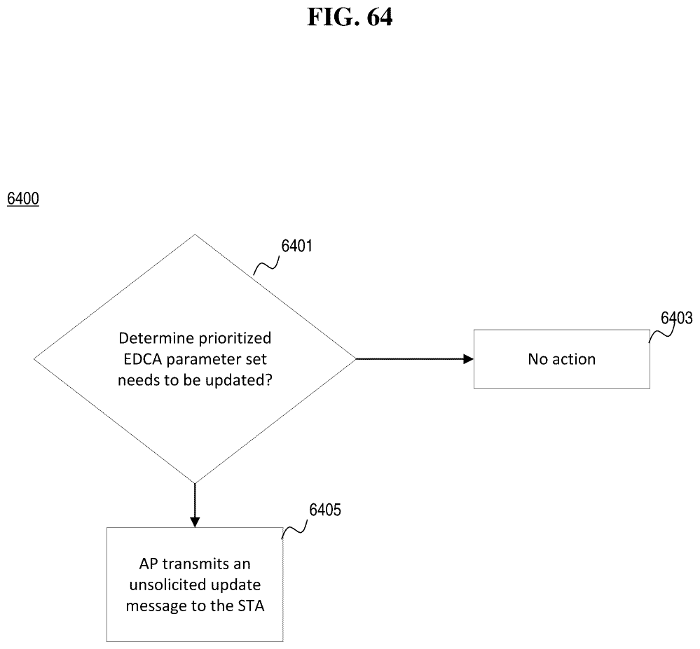

FIG. 64 illustrates a flow chart of an example process of by an AP of an unsolicited update message in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 64 illustrates operations performed in a AP, such as the AP illustrated in FIG. 3.

The process 6400, in operation 6401, the AP determines whether a prioritized EDCA parameter set needs to be updated. If the AP determines that a prioritized EDCA parameter set does not need to be updated, the process proceeds to operation 6403 and the AP performs no action. If the AP determines that a prioritized EDCA parameter set needs to be updated, the process proceeds to operation 6405.

In operation 6405, the AP transmits to the STA an unsolicited update message that may include the updated prioritized EDCA parameter set. In some embodiments, the AP can transmit a prioritized EDCA parameter set in its management frames (e.g., beacons). STAs that are authorized for an LL session can use the prioritized EDCA parameter set advertised in the beacons.

In some embodiments, when the AP wants to update the prioritized EDCA parameter set, it can update the prioritized EDCA parameter set advertised in beacons. STA that are authorized for an LL session can start to use that prioritized EDCA parameter set.

In some embodiments, the advertisement in the beacon can include at least one or more of the information items as indicated in Table 11.

Table 11 illustrates an advertisement message in beacons in accordance with an embodiment.

TABLE 11

| Information | |
|---|---|
| item | Description |
| Prioritized | One or more information item(s) that describe the |
| EDCA | prioritized EDCA and MU EDCA parameter set. e.g., a |
| parameter set | prioritized EDCA parameter set element. |
| Update time | One or more information item(s) that can describe the time |
| | at which the update can happen. e.g., the number of TBTTs |
| | from the current TBTT at which the update can occur. |

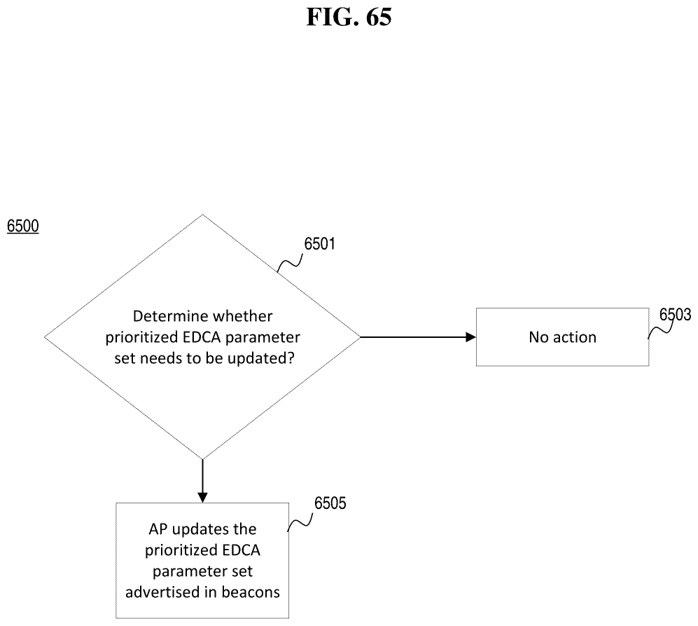

FIG. 65 illustrates a flow chart of an example process by an AP of management frame-based update procedure in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 65 illustrates operations performed in a AP, such as the AP illustrated in FIG. 3.

The process 6500, in operation 6501, the AP determines whether a prioritized EDCA parameter set needs to be updated. If the AP determines that a prioritized EDCA parameter set does not need to be updated, the process proceeds to operation 6503 and performs no action. If the AP determines that a prioritized EDCA parameter set needs to be updated, the process proceeds to operation 6505.

In operation 6505, the AP updates the prioritized EDCA parameter set advertised in beacons. In some embodiments, the AP can transmit a prioritized EDCA parameter set in its management frames (e.g., beacons). STAs that are authorized for an LL session can use the prioritized EDCA parameter set advertised in the beacons.

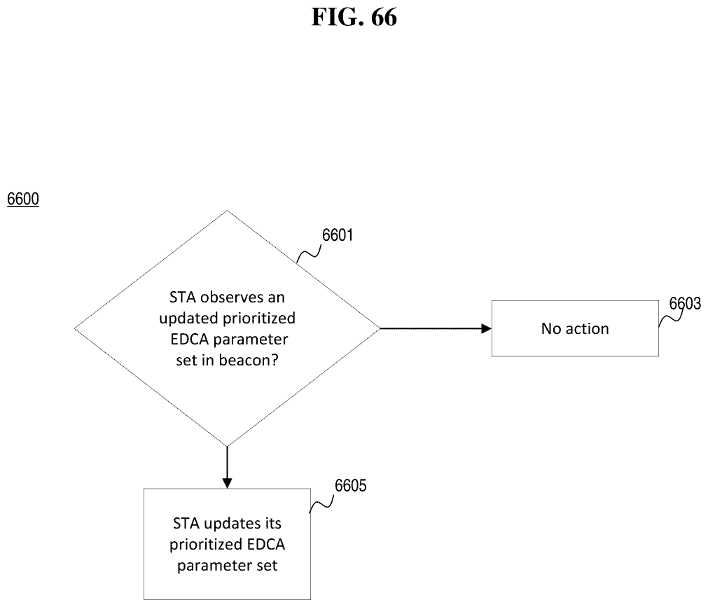

FIG. 66 illustrates a flow chart of an example process by a STA for management-based update procedure in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 66 illustrates operations performed in a STA, such as the STA illustrated in FIG. 3.

The process 6600, in operation 6601, the STA determines whether the STA observes an updated prioritized EDCA parameter set in a beacon. If the STA determines that the STA does not observe an updated prioritized EDCA parameter set in a beacon, the process proceeds to operation 6603 and the STA performs no action. If the STA determines that the STA does observe an updated prioritized EDCA parameter set in a beacon, the process proceeds to operation 6605.

In operation 6605, the STA updates its prioritized EDCA parameter set as soon as possible.

In some embodiments, the AP can degrade the normal EDCA parameter set in its beacons to maintain the priority access provided to LL STAs. In some embodiments, degrading the EDCA parameter set can include using weaker values for one or more of the AIFSN, CWmin, CWmax, and TXOP than the normal values, whereby contending for the channel and winning the channel is made probable in relation to using a normal EDCA parameter set to contend for the channel.

In some embodiments, when the network and traffic conditions return to normal, the AP can bring the normal EDCA parameter set to its original value.

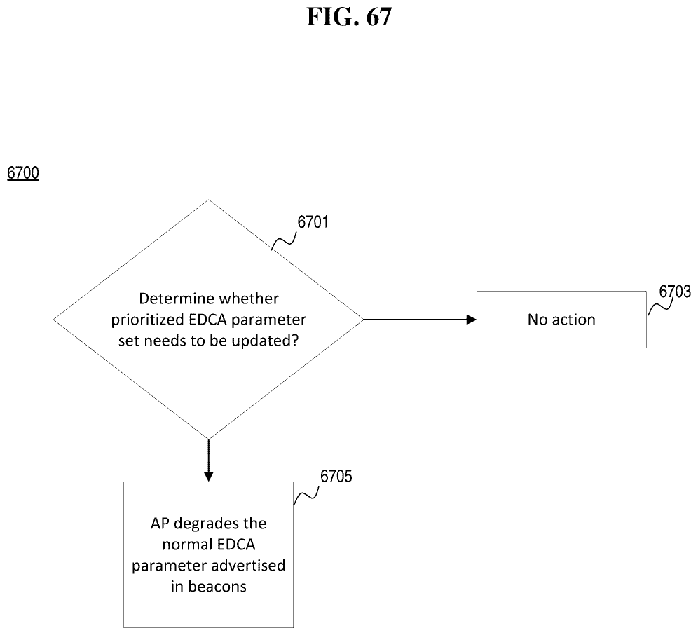

FIG. 67 illustrates a flow chart of an example process by an AP of degrading the normal EDCA parameter set in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 67 illustrates operations performed in a AP, such as the AP illustrated in FIG. 3.

The process 6700, in operation 6701, the AP determines whether a prioritized EDCA parameter set needs to be updated. If the AP determines that a prioritized EDCA parameter set does not need to be updated, the process proceeds to operation 6703 and the AP performs no action. If the AP determines that a prioritized EDCA parameter set needs to be updated, the process proceeds to operation 6705.

In operation 6705, the AP degrades the normal EDCA parameter set advertised in beacons. In some embodiments, degrading the EDCA parameter set can include using weaker values for one or more of the AIFSN, CWmin, CWmax, and TXOP than the normal values, whereby contending for the channel and winning the channel is made probable in relation to using a normal EDCA parameter set to contend for the channel.

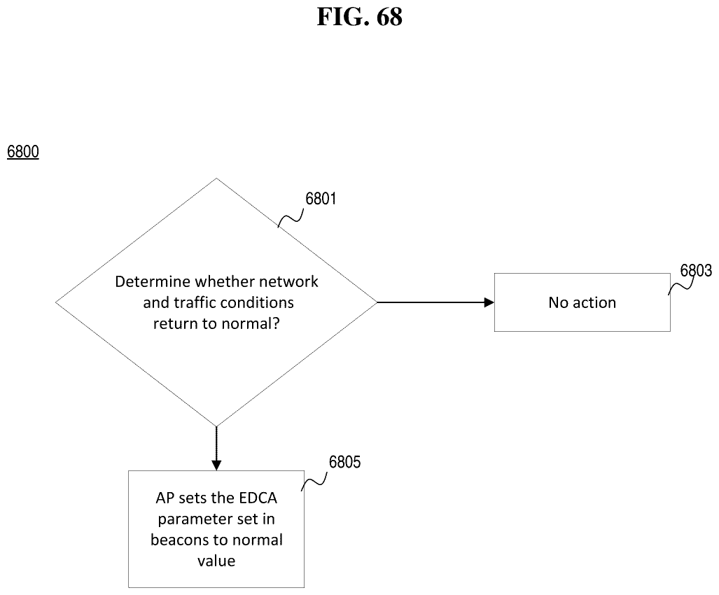

FIG. 68 illustrates a flow chart of an example process by an AP of returning EDCA values to their original state in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 68 illustrates operations performed in a AP, such as the AP illustrated in FIG. 3.

The process 6800, in operation 6801, the AP determines whether network and traffic conditions have returned to normal. If the AP determines that network and traffic conditions have not returned to normal, the process proceeds to operation 6803 and perform no action. If the AP determines that network and traffic conditions have returned to normal, the process proceeds to operation 6805.

In operation 6805, the AP sets the EDCA parameter set in beacons to normal values (e.g., normal values for AIFSN, CWmin, CWmax, and TXOP, among others).

In some embodiments, the AP can advertise multiple EDCA operation parameters in its management frames (e.g., beacons) or during LL session setup. The AP can also indicate which is the current EDCA parameters when authorizing the STAs and also in its beacons. When the AP determines the need to update the EDCA parameters, the AP can indicate in the beacon which is the current EDCA parameter set. STAs can update their EDCA parameters to the one indicated by the AP.

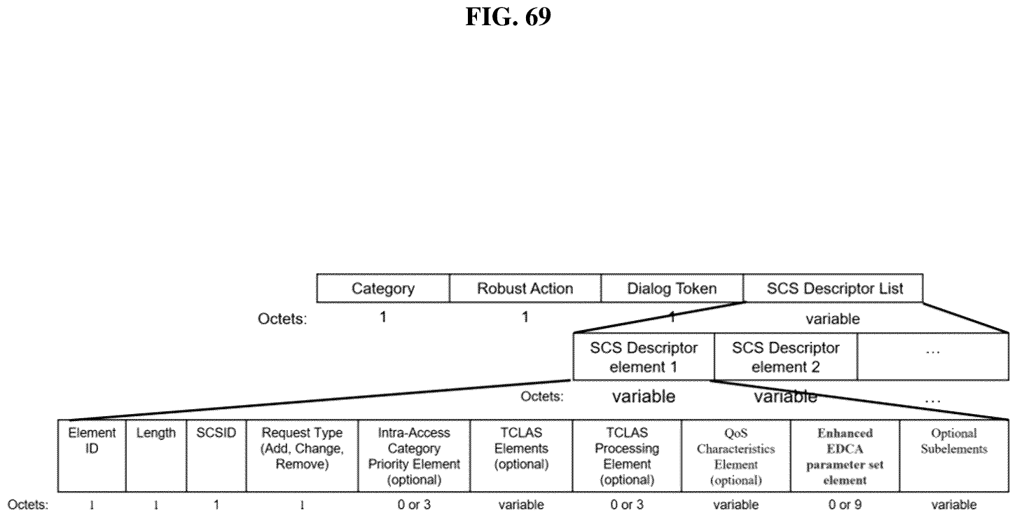

In some embodiments, an update can be achieved via an unsolicited SCS response frame. In some embodiments, the AP can transmit an unsolicited SCS response frame to the STA. The response frame can have a format as shown in FIG. 69 in accordance with an embodiment.

FIG. 69 illustrates an SCS response frame structure in accordance with an embodiment. The SCS response frame illustrated in FIG. 69 may have similar fields as already described herein with reference to FIG. 59, and those descriptions are omitted. As illustrated in FIG. 69, the SCSID field can correspond to the SCSID that was assigned when the LL session or priority access was setup. The Request type field can be set to change. The SCS descriptor element can include a prioritized EDCA parameter set element field which can include the updated parameters.

In some embodiments, when the STA receives the prioritized EDCA parameter set element, the STA can update its EDCA parameters.

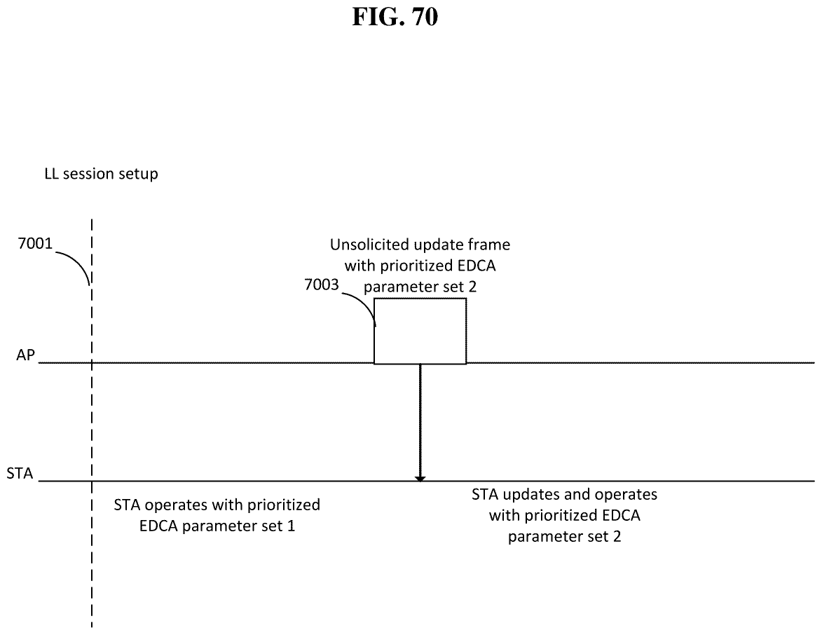

FIG. 70 illustrates an example EDCA update operation in accordance with an embodiment. In particular, FIG. 70 illustrates communication between an AP and STA1. Initially, an LL session or priority access session may be setup 7001 and the STA may operate with a prioritized EDCA parameter set 1. The AP transmits to STA1 an unsolicited update frame 7003 with a prioritized EDCA parameter set 2. Accordingly, STA1 may update and operate with the prioritized EDCA parameter set 2. In particular, when the AP detects the need to update STA1's prioritized EDCA parameter set, the AP can transmit the unsolicited update frame 7001 to the STA with the prioritized EDCA parameter set 2. The STA can update its prioritized EDCA parameter set to this value and start to use it.

Embodiments in accordance with this disclosure provide low latency applications be priority access to the wireless medium. In some embodiments, priority access can be provided by giving the authorized device a prioritized EDCA parameter set where the values of the prioritized EDCA parameter set can be designed by the entity providing the set in such a manner that the authorized device using the parameter set can gain priority access compared to other devices that are not authorized, improving wireless communications and performance of low latency applications.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
determine that the STA has low-latency traffic to be transmitted;
determine that the STA is authorized for priority access to a channel;
contend for the channel using a prioritized enhanced distributed channel access (EDCA) parameter set, the prioritized EDCA parameter set providing priority access to the channel; and
transmit, to an access point (AP), the low-latency traffic via the channel.

2. The STA of claim 1, wherein the processor is configured to:
determine that the STA is authorized for priority access to the channel based on a determination that a latency tolerance indicated by a quality of service (QOS) established between the STA and the AP is less than a channel access delay.

3. The STA of claim 1, wherein the processor is configured to:
determine that the STA is authorized for priority access to the channel based on a determination that a number of packet drops due to latency requirement exceed a threshold.

4. The STA of claim 1, wherein the processor is further configured to:
transmit, to the AP, a request frame that requests priority access to the channel; and
receive, from the AP, a response frame in response to the request frame that authorizes priority access to the channel and includes the prioritized EDCA parameter set.

5. The STA of claim 1, wherein the processor is further configured to:
receive, from the AP, an unsolicited frame that authorizes priority access to the channel and includes the prioritized EDCA parameter set.

6. The STA of claim 1, wherein the processor is further configured to:
receive, from the AP, a frame that terminates authorization for priority access to the channel; and
contend for the channel using a non-priority EDCA parameter set.

7. The STA of claim 1, wherein the processor is further configured to:
receive, from the AP, a frame that authorized priority access to the channel and includes a plurality of prioritized EDCA parameter sets including a first prioritized EDCA parameter set and a second prioritized EDCA parameter set;
transmit, to the AP, a first low-latency traffic using the first prioritized EDCA parameter set; and
transmit, to the AP, a second low-latency traffic using the second prioritized EDCA parameter set.

8. The STA of claim 1, wherein the processor is further configured to:
transmit a defer signal using the prioritized EDCA parameter set to block one or more STAs from contending for the channel during a time period.

9. An access point (AP) in a wireless network, the AP comprising:
a memory; and
a processor coupled to the memory, the processor configured to:
transmit, to a station (STA), a frame that includes a prioritized enhanced distributed channel access (EDCA) parameter set, the prioritized EDCA parameter set providing priority access to a channel; and
receive, from the STA, the low-latency traffic via the channel, the low-latency traffic being transmitted based on the prioritized EDCA parameter set.

10. The AP of claim 9, wherein the processor is configured to:
receive, from the STA, a request frame that request priority access to the channel, wherein the frame is transmitted in response to the request frame.

11. The AP of claim 10, wherein the request frame indicates that a latency tolerance indicated by a quality of service (QOS) established between the STA and the AP is less than a channel access delay.

12. The AP of claim 10, wherein the request frame indicates that a number of packet drops due to latency requirement exceed a threshold.

13. The AP of claim 9, wherein the frame that includes the prioritized EDCA parameter set is an unsolicited frame.

14. The AP of claim 9, wherein the processor is further configured to:
transmit, to the STA, another frame that terminates authorization for priority access to the channel.

15. The AP of claim 9, wherein the frame includes a plurality of prioritized EDCA parameter sets including a first prioritized EDCA parameter set and a second prioritized EDCA parameter set; wherein the processor is further configured to:
receive, from the STA, a first low-latency traffic that is transmitted based on the first prioritized EDCA parameter set; and
receive, from the STA, a second low-latency traffic that is transmitted based on the second prioritized EDCA parameter set.

16. The AP of claim 9, wherein the processor is further configured to:
transmit a defer signal using the prioritized EDCA parameter set to block one or more STAs from contending for the channel during a time period.

17. A computer-implemented method for wireless communication by a station (STA) in a wireless network, comprising:
determining that the STA has low-latency traffic to be transmitted;
determining that the STA is authorized for priority access to a channel;
contending for the channel using a prioritized enhanced distributed channel access (EDCA) parameter set, the prioritized EDCA parameter set providing priority access to the channel; and
transmitting, to an access point (AP), the low-latency traffic via the channel.

18. The computer-implemented method of claim 17, further comprising:
determining that the STA is authorized for priority access to the channel based on a determination that a latency tolerance indicated by a quality of service (QOS) established between the STA and the AP is less than a channel access delay.

19. The computer-implemented method of claim 17, further comprising:
determining that the STA is authorized for priority access to the channel based on a determination that a number of packet drops due to latency requirement exceed a threshold.

20. The computer-implemented method of claim 17, further comprising:
transmitting, to the AP, a request frame that requests priority access to the channel; and
receiving, from the AP, a response frame in response to the request frame that authorizes priority access to the channel and includes the prioritized EDCA parameter set.
